(19) United States
(12) Patent Application Publication
(10) Pub. No.: US 2009/0297976 A1
(43) Pub. Date: Dec. 3, 2009

(54) TONER KIT, IMAGE FORMATION METHOD AND IMAGE FORMING APPARATUS

(76) Inventors: Atsushi YAMAMOTO, Kawanishi-shi (JP); Tsuyoshi Nozaki, Ikeda-shi (JP); Shuuichi Nakagawa, Suita-shi (JP)

Correspondence Address: OBLON, SPIVAK, MCCLELLAND MAIER & NEUSTADT, L.L.P., 1940 DUKE STREET, ALEXANDRIA, VA, 22314, US

(21) Appl. No.: 12/476,763

(22) Filed: Jun. 2, 2009

(30) Foreign Application Priority Data
Jun. 3, 2008 (JP) 2008-145987

(51) Int. Cl. G03G 9/087; G03G 9/08; G03G 21/20; G03G 13/20

(52) U.S. Cl. 430/109.4; 430/105; 430/110.1; 430/109.1; 399/44; 430/124.1; 430/124.3

(57) ABSTRACT

A toner kit including a color toner containing a first binder resin and a coloring agent; transparent and colorless resin particulates comprising a second binder resin, wherein the half effusion temperature of the color toner and the half effusion temperature of the transparent and colorless resin particulates measured by a flow tester satisfy the following relationship: (the half effusion temperature of the color toner measured by the flow tester)−(the half effusion temperature of the transparent and colorless particulates measured by the flow tester)>30° C.

### BACKGROUND OF THE INVENTION

1. Field of the Invention

The present invention relates to a toner kit, and an image forming apparatus and image formation method using the toner kit.

2. Discussion of the Background

Toner and development devices have been variously improved to improve quality grade of images and obtain images having a wide range of color reproducibility with regard to image forming apparatus.

For example, fine line reproducibility and reduction in size of toner have been improved for quality degrade and toner that has a form closer to a sphere has been developed to improve transfer efficiency.

However, the inventors of the present invention have studied these and found problems with regard to images during fixing.

These are, (1) unevenness in a halftone image stands out, and (2) sharp portions of fonts such as angles of a square, part of a stroke in Mincho font, which is called “Harai”, and end portions of Times New Roman font are crushed.

The problem (1) is caused by impregnation of toner particles melted upon application of hear and pressure during fixing into fibers. The problem (2) stems from the crush of a toner image during application of heat and pressure.

Unexamined published Japanese patent applications Nos. (hereinafter referred to as Nos.) 2007-47365, 2006-285006, 2003-114587, and 2001-215767 describe definitions on the viscosity of toner or binder resins or the hardness of the rollers for use in the fixing portion.

However, the image deterioration during fixing is still unavoidable after these definitions are applied. Therefore, it is thinkable that the image deterioration caused by fixing is caused by factors different from those identified for deterioration during development or transfer.

In addition, suitable image gloss is also required.

JOPs 2004-20861, 2006-209090 and Japanese patent No. 3526629 describe usage of color toner in combination with transparent toner to impart gloss to images.

JOP 2004-20861 describes usage of transparent toner having a viscosity of 10³ Pa·s in the temperature range of from 80 to 130° C. in combination with color toner having a viscosity close to that of the transparent toner.

JOP 2006-209090 describes a technology that white toner or transparent toner has a storage elastic modulus at the fixing temperature in the fixing nip where recording medium is nipped between, for example, a pressure roller and a heat roller, set to be higher than that of each color toner during fixing.

Japanese patent No. 3526629 describes usage of color toner and an adhesive transparent toner having a glass transition temperature lower than that of the color toner.

However, these methods are suitable to impart gloss but not sufficient to prevent image deterioration.

### SUMMARY OF THE INVENTION

Because of these reasons, the present inventors recognize that a need exists for a toner kit, image formation method, and image forming apparatus which obtain images representing a wide range of color reproducibility with excellent printing grade particularly by reducing the image disturbance caused by pressure and heating fixing.

Accordingly, an object of the present invention is to provide a toner kit image formation method, and image forming apparatus which obtain images representing a wide range of color reproducibility with excellent printing grade, particularly by reducing the image disturbance caused by pressure and heating fixing.

Briefly this object and other objects of the present invention as hereinafter described will become more readily apparent and can be attained, either individually or in combination thereof, by a toner kit including a color toner containing a first binder resin and a coloring agent; transparent and colorless resin particulates comprising a second binder resin, wherein the half effusion temperature of the color toner and the half effusion temperature of the transparent and colorless resin particulates measured by a flow tester satisfy the following relationship:

(the half effusion temperature of the color toner measured by the flow tester)−(the half effusion temperature of the transparent and colorless particulates measured by the flow tester)>30° C.

It is preferred that, in the toner kit mentioned above, the half effusion temperature of the color toner measured by the flow tester is 150° C. or higher, and the half effusion temperature of the transparent and colorless resin particulates measured by the flow tester is 120° C. or lower.

It is still further preferred that, in the toner kit mentioned above, the color toner has a volume average particle diameter of from 2 to 8 μm.

It is still further preferred that, in the toner kit mentioned above, the color toner has an average circularity of 0.950 or higher.

It is still further preferred that, in the toner kit mentioned above, the transparent and colorless resin particulates further comprises a releasing agent in an amount of from 2 to 40% by weight.

It is still further preferred that, in the toner kit mentioned above, the color toner further contains a releasing agent in an amount of 4% or lower by weight.

It is still further preferred that, in the toner kit mentioned above, 70% by weight of the first binder of the color toner and 70% by weight of the second binder of the transparent and colorless resin particulates comprise polyester units.

It is still further preferred that, in the toner kit mentioned above, 70% by weight of the first binder resin of the color toner and 70% by weight of the second binder resin of the transparent and colorless resin particulates comprise vinyl polymer units.

As another aspect of the present invention, an image forming apparatus is provided which includes at least one first image bearing member, each of which bears a first latent electrostatic image thereon; a second image bearing member that bears a second latent electrostatic image thereon, at least one first charging device, each of which uniformly and correspondingly charges the surface of one of the at least one first image bearing member; a second charging device that uniformly and correspondingly charges the surface of the second image bearing member; an irradiation device that irradiates each surface of the at least one first image bearing member and the second image bearing member according to image data to respectively write the first latent electrostatic image on each of the surface of each of the at least one first image bearing member and the second latent electrostatic image on the second image bearing member; at least one first development device, each of which contains a first development agent bearing member that bears a first development agent containing a color toner containing a first binder resin and a coloring agent on the surface of the first development agent bearing member, a first development agent container that accommodates the first development agent, and a first development agent supplying member that supplies the first development agent to the surface of the first development agent bearing member, the at least one first development device developing the first latent electrostatic image on each surface of the at least one first image bearing member with the color toner to obtain at least one visualized image; a second development device including a second development agent bearing member that bears a second development agent containing a transparent and colorless resin particulates comprising a second binder resin on the surface of the second development agent bearing member, a second development agent container that accommodates the second development agent, and a second development agent supplying member that supplies the second development agent to the surface of the second development agent bearing member, the second development device forming a transparent and colorless image on the surface of the second image bearing member with the transparent and colorless resin particulates; a transfer device that transfers the at least one visualized image and the transparent and colorless image to a recording medium; and a fixing device that fixes the at least one visualized image and the transparent and colorless image on the recording medium. In the image forming apparatus, the half effusion temperature of the color toner and the half effusion temperature of the transparent and colorless resin particulates measured by a flow tester satisfy the following relationship: (the half effusion temperatures of the color toner measured by the flow tester)−(the half effusion temperatures of the transparent and colorless particulates measured by the flow tester)>30° C.

It is still further preferred that, in the image forming apparatus mentioned above, the fixing device includes a heating device containing an elastic layer and a heat source, and a pressure device which forms a nip portion with the heating device where the recording medium is nipped by the heating device and the pressure device and the pressure device has an ASKER C hardness of from 45 to 80°.

As another aspect of the present invention, an image formation method is provided which includes forming an image formed of color toner and a transparent and colorless image formed of transparent and colorless resin particulates to obtain a toner image; and fixing the toner image on a recording medium, wherein the color toner contains a first binder resin and a coloring agent and the transparent and colorless resin particulates contains a second binder resin and, wherein the half effusion temperature of the color toner and the half effusion temperature of the transparent and colorless resin particulates measured by a flow tester satisfy the following relationship: (the half effusion temperatures of the color toner measured by the flow tester)−(the half effusion temperatures of the transparent and colorless particulates measured by the flow tester)>30° C.

It is preferred that, in the image formation method mentioned above, the half effusion temperature of the color toner measured by the flow tester is 150° C. or higher, and the half effusion temperature of the transparent and colorless particulates measured by the flow tester is 120° C. or lower.

It is still further preferred that, in the image formation method mentioned above, the step of fixing is conducted when the recording medium bearing unfixed toner image formed of the color toner and the transparent and colorless resin particulates passes through a nip portion where a heating device including an elastic layer and a heat source nip the recording medium with and a pressure device.

It is still further preferred that, in the image formation method mentioned above, the pressure device has an ASKER C hardness of from 45 to 80°.

It is still further preferred that, in the image formation method mentioned above, the recording medium passes through the nip portion at from 150 to 500 mm/s.

These and other objects, features and advantages of the present invention will become apparent upon consideration of the following description of the preferred embodiments of the present invention taken in conjunction with the accompanying drawings.

### BRIEF DESCRIPTION OF THE DRAWINGS

Various other objects, features and attendant advantages of the present invention will be more fully appreciated as the same becomes better understood from the detailed description when considered in connection with the accompanying drawings in which like reference characters designate like corresponding parts throughout and wherein:

FIG. 1 is a diagram illustrating a cross section of an example of the main part of the development device and the process cartridge related to the present invention;

FIG. 2 is a diagram illustrating a cross section of an example of the development device and the process cartridge related to the present invention; and

FIG. 3 is a diagram illustrating an example of the fixing device related to the present invention.

### DETAILED DESCRIPTION OF THE INVENTION

The present invention will be described below in detail with reference to several embodiments and accompanying drawings.

The present inventors have made an intensive study and accordingly found that the problems stemming from imparting gloss to images and preventing image deterioration caused by fixing are solved by a toner kit containing color toner having particular viscosity characteristics and transparent resin particles to assume separate functions and by using the toner kit in an image forming apparatus including a fixing device having a pressure device having a particular surface hardness.

Kit in the toner kit generically represents a combination of toner and resin particulates simultaneously set in an image forming apparatus (or development device).

Images obtained by using a toner kit containing toner and resin particulates under mutual specific conditions fill the purpose of the present invention.

Therefore, kit does not necessarily mean a product set of a toner and resin particulates which is circulated in the market.

The image forming apparatus of the present invention includes at least one first image bearing member, each of which bears a first latent electrostatic image thereon; a second image bearing member that bears a second latent electrostatic image thereon; at least one first charging device, each of which uniformly and correspondingly charges the surface of one of the at least one first image bearing member; a second charging device that uniformly and correspondingly charges the surface of the second image bearing member; an irradiation device that irradiate each surface of the at least one first image bearing member and the second image bearing member according to image data to respectively write the first latent electrostatic image on each of the surface of each of the at least one first image bearing member and the second latent electrostatic image on the second image bearing member; at least one first development device, each of which includes a first development agent bearing member that bears a first development agent including a color toner containing a first binder resin and a coloring agent on the surface of the first development agent bearing member, a first development agent container that accommodates the first development agent, and a first development agent supplying member that supplies the first development agent to the surface of the first development agent bearing member, and which develops the first latent electrostatic image on each surface of the at least one first image bearing member with the color toner to obtain at least one visualized image; a second development device that includes a second development agent bearing member that bears a second development agent containing a transparent and colorless resin particulates containing a second binder resin on the surface of the second development agent bearing member, a second development agent container that accommodates the second development agent, and a second development agent supplying member that supplies the second development agent to the surface of the second development agent bearing member, and which forms a transparent and colorless image on the surface of the second image bearing member with the transparent and colorless resin particulates; a transfer device that transfers the at least one visualized image and the transparent and colorless image to a recording medium; and a fixing device that fixes the at least one visualized image and the transparent and colorless image on the recording medium. In the image forming apparatus, the half effusion temperature of the color toner and the half effusion temperature of the transparent and colorless resin particulates measured by a flow tester satisfy the following relationship: (the half effusion temperatures of the color toner measured by the flow tester)−(the half effusion temperatures of the transparent and colorless particulates measured by the flow tester)>30° C. In addition, in the image forming apparatus, the irradiation device may be provided for each of the at least one first image bearing member and the second image bearing member. That is, the image forming apparatus may include multiple irradiation devices.

An example structure of the present invention is described below.

### Development Device and Process Cartridge

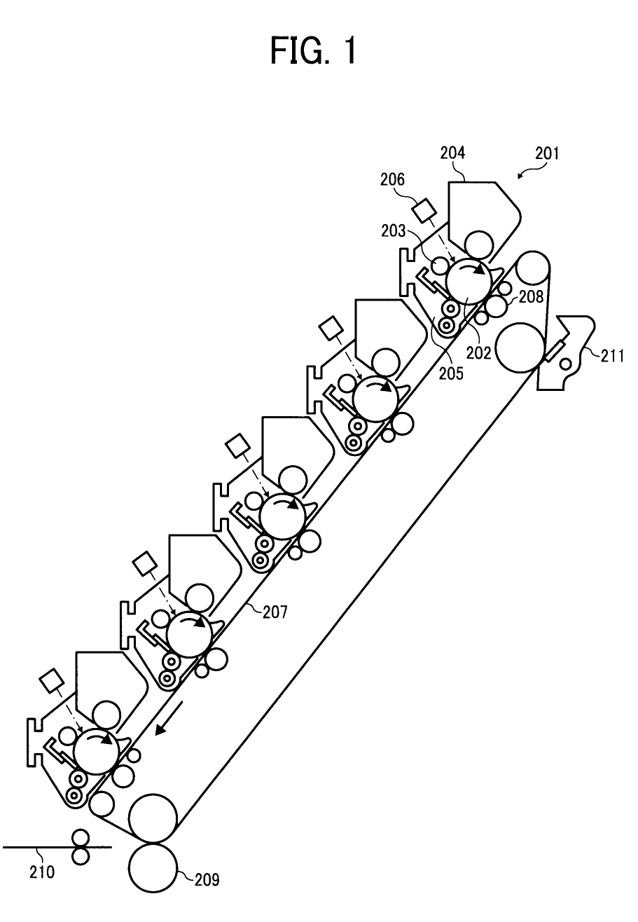

FIG. 1 is a diagram illustrating a cross section of the main part of an image forming apparatus including the development devices and process cartridge units related to the present invention.

Each process cartridge unit 201 has a structure in which an image bearing member drum 202, a charging roller 203, a development device 204 and a cleaning device 205 are integrally combined. Each process cartridge unit 201 is replaceable by releasing each stopper.

The image bearing member drum 202 rotates at a circumference velocity of 150 mm/s in the direction indicated by an arrow.

The charging roller 203 is pressed against the surface of the image bearing member drum 202 and driven by the rotation of the image bearing member drum 202. A predetermined bias is applied to the charging roller 203 by a high voltage power source (not shown) to charge the surface of image bearing member drum at −500 V.

An irradiation device 206 irradiates the image bearing member 202 with light according to obtained image data to form a latent electrostatic image on the image bearing member drum 202. A laser beam scanner using a laser diode or an LED is used as the irradiation device 206. The development device 204 that accommodates a color toner or transparent and colorless resin particulates performs a single or two component contact development and visualizes the latent electrostatic image when the development device 204 accommodates a color toner. A high voltage power source (not shown) applies a predetermined development bias to the development device 204. The cleaning device 205 cleans the surface of the image bearing member drum 202 by removing the color toner or the transparent and colorless resin particulates remaining thereon.

Five of the process cartridges 201 are arranged in parallel with the moving direction of a transfer device (an intermediate transfer belt 207 in this case). For example, the development device 204 situated on the most upstream side in FIG. 1 accommodates transparent and colorless resin particulates and other four development devices 204 accommodate yellow, cyan, magenta, and black toner in this sequence from the upstream side by which latent electrostatic images are visualized. A primary transfer bias is applied to the primary transfer roller 208 and the visualized toner image or a transparent and the colorless image on the surface of the image bearing member drum 202 is transferred to the intermediate transfer belt 207. The intermediate transfer belt 207 is rotationary driven by a driving motor (not shown) in the direction indicated by an arrow in FIG. 1. Each visualized color image or the transparent and colorless image is transferred and overlapped sequentially to form a full color image.

The formed full color image is transferred to a recording medium (transfer material: paper) 210 by a predetermined voltage applied to a secondary transfer roller 209, fixed thereon with a fixing device (not shown) and thereafter output. Toner or transparent and colorless resin particulates remaining on the intermediate transfer belt 207 which have not been transferred by the secondary transfer roller 209 is collected by a transfer belt cleaning device 211.

Multiple development devices are used in the present invention and each includes a development agent container. The development agent container accommodates color toner or transparent and colorless resin particulates. The development device includes a development agent supply member and a development agent bearing member. The development agent supply member supplies a development agent containing color toner or transparent and colorless resin particulates to the surface of the development agent bearing member from the development agent container and the development agent bearing member bears the supplied development agent on the surface thereof.

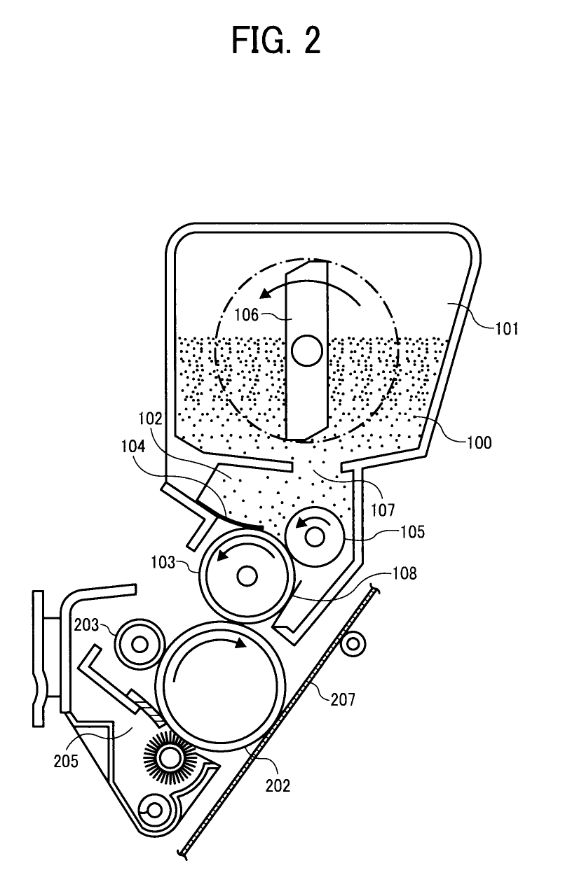

FIG. 2 is a cross section of the development device and the process cartridge related to an embodiment of the present invention.

The development device 204 is structured by a toner (or transparent and colorless resin particulate) container room 101 that accommodates toner (or transparent and colorless resin particulate) 100, a toner (or transparent and colorless resin particulate) supply room 102 provided under the toner (or transparent and colorless resin particulate) container room 101, a development roller 103 provided under the toner (or transparent and colorless resin particulate) supply room 102, and a layer regulation member 104 and a supply roller 105 provided in contact with the development roller 103. The development roller 103 is arranged in contact with an image bearing member drum 2 and a predetermined development bias is applied to the development roller 103 by a high voltage power supply (not shown).

A toner (or transparent and colorless resin particulate) stirring member 106, which is provided in the toner (or transparent and colorless resin particulate) container room 101, rotates counterclockwise to cause the accommodated toner (or transparent and colorless resin particulate) to flow and accelerate drop of the toner (or transparent and colorless resin particulate) 100 through an opening 107 to the toner (or transparent and colorless resin particulate) supply room 102. The opening 107 is provided right above the supply roller 105 and right above the layer regulation member 104 is only a separation wall between the toner (or transparent and colorless resin particulate) container room 101 and the toner (or transparent and colorless resin particulate) supply room 102. Foam material having a cell structure covers the surface of the supply roller 105. Therefore, the toner (or transparent and colorless resin particulate) 100 dropped into the toner (or transparent and colorless resin particulate) supply room 102 is efficiently taken in and attached to the supply roller 105 and is prevented from deterioration due to the pressure concentration at the contact portion of the development roller 103. Furthermore, the foam material is electroconductive containing carbon particulates and is set to have an electric resistance of from 10³ to 10⁵Ω. A supply bias to offset the development bias in the same direction as the charging polarity is applied to the development bias. This supply bias functions to press to the development roller 103 the toner (or transparent and colorless resin particulate) 100 preliminarily charged at the contact portion with the development roller 103. The supply roller 105 rotates counterclockwise and supplies and applies the toner (or transparent and colorless resin particulate) 100 attached to the surface of the supply roller 105 to the surface of the development roller 103.

A roller covered with an elastic rubber layer is used as the development roller 103 and a surface coating layer formed of material easily charged with a reverse polarity to that of the toner (or transparent and colorless resin particulate) 100 is provided to the development roller 103. The elastic rubber layer is set to have a hardness of 60° according to JIS-A to keep a uniform contact status with the image bearing member drum 202, an electric resistance of from 10³ to 10⁵ to cause the development bias to work, and a surface roughness Ra of from 0.3 to 2.0 μm to bear a required amount of the toner (or transparent and colorless resin particulate) 100 on the surface. The development roller 103 rotates counterclockwise and conveys the toner (or transparent and colorless resin particulate) 100 borne on the surface of the development roller 103 to the layer regulation member 104 and the position facing the image bearing member drum 202.

The layer regulation member 104 is provided at a position lower than the contact portion of the supply roller 105 and the development roller 103. The layer regulation member is formed of metal board spring material such as SUS or phosphor bronze and the free end thereof is pressed against the surface of the development roller 103 with a pressure of from 10 to 40 N/m. The toner (or transparent and colorless resin particulate) 100 passing through the layer regulation member 104 under the pressure is regulated with regard to the layer thickness and triboelectrically charged. To assist the triboelectirc charging, a regulation bias to offset the development bias in the same direction as the charging polarity of the toner (or transparent and colorless resin particulate) 100 is applied to the layer regulation member 104.

Specific examples of the rubber elastic bodies structuring the surface of the development roller 103 include, but are not limited to, copolymer rubber of styrene and butadiene, copolymer rubber of acrylonitrile and butadiene, acryl rubber, epichlorohydrin rubber, urethane rubber, silicone rubber, and mixtures thereof. Among these, blended rubber of epichlorohydrin rubber and the copolymer rubber of acrylonitrile and butadiene is preferably used.

The development roller for use in the present invention is manufactured by, for example, covering the outer surface of an electroconductive shaft with rubber elastic body. The electroconductive shaft is structured by, for example, metal such as stainless steel.

The image bearing member drum 2 rotates clockwise and thus the surface of the development roller 103 moves in the same direction as that of the image bearing member drum 202 at the position facing the image bearing member 202.

The toner (or transparent and colorless resin particulate) 100 regulated at the layer regulation member 104 is conveyed to the facing position with the image bearing member drum 202 by the rotation of the development roller 103. Thereafter, the toner (or transparent and colorless resin particulate) 100 moves to the surface of the image bearing member 202 by the development bias applied to the development roller 103 and the latent image electric field formed by the latent electrostatic image on the image bearing member drum 202 and develops the latent electrostatic image. A seal 108 is provided in contact with the development roller 103 to the portion where color toner (or transparent and colorless resin particulate) that has not developed the latent electrostatic image on the image bearing member drum 202 but remains on the development roller 103 is returned to the toner (or transparent and colorless resin particulate) supply room 102 so that the remaining toner (or transparent and colorless resin particulate) does not slip outside the development device 204.

The structure of the charging member of the latent electrostatic image bearing member is described below.

The charging member for use in the present invention has a cylinder form as a whole including a core metal on which an electroconductive layer and a surface layer covering the electroconductive layer are provided. A voltage applied to the core metal by a power supply is applied to the image bearing member drum 202 by way of the electroconductive layer and the surface layer so that the surface of the image bearing member drum 202 is charged.

The core metal of the charging member is arranged in the longitudinal direction, i.e., in parallel to the axis of the image bearing member drum 202) of the image bearing member drum 202 and the entire charging member is pressed against the image bearing member drum 202 with a predetermined pressure. Part of the surface of the image bearing member drum 202 and part of the surface of the charging member are brought into contact with each other in the longitudinal direction to form a contact nip having a predetermined width. The image bearing member drum 202 is rotationary driven by a driving force (not shown) and the charging member is driven according to the image bearing member drum 202.

The image bearing member drum 202 is charged by a power supply by way of the vicinity of the contact nip mentioned above. The surface of the charging member and the charged area (corresponding to the length of the charging member) on the surface of the image bearing member drum 202 are uniformly in contact with each other. Therefore, the charged area of the surface of the image bearing member drum 202 is uniformly charged.

The electroconductive layer of the charging member is non-metal and material having a low hardness is preferably used therefor to stabilize the contact state with the image bearing member drum 202. For example, resins such as polyurethane, polyether, and polyvinyl alcohol or rubber such as hydrin-based rubber, EPDM and NBR are used. Carbon black, graphite, titanium oxide, zinc oxide, etc. can be used as the electroconductive material. Material having an electric resistance in the middle range (10² to 10¹⁰Ω) is used for the surface layer. Specific examples of the resins include, but are not limited to, nylon, polyamide, polyurethane, polyester, silicone, Teflon®, polyacetylene, polypyrrole, polythiophene, polycarbonate, and polyvinyl. Using fluorine-based resins is preferable to increase the contact angle with water. Specific examples of the fluorine-based resins include, but are not limited to, polyvinylidene fluoride, polyethylene fluoride, copolymers of vinylidene fluoride and tetrafluoroethylene, copolymers of vinylidene, tetrafluoroethylene and propylene hexafluoride.

Furthermore, electroconductive material such as carbon black, graphite, titanium oxide, zinc oxide, tin oxide and iron oxide can be suitably added to adjust the electric resistance of the surface layer to be in the middle range mentioned above.

Below is a description about an example of the fixing device employing a fixing roller system applied to the present invention.

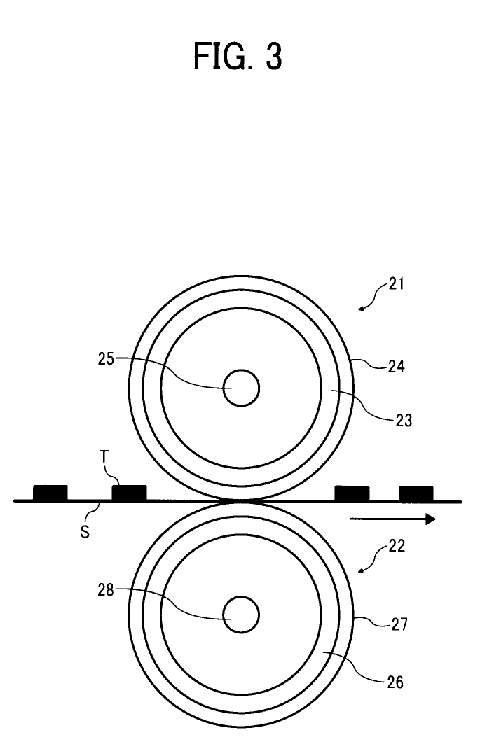

The fixing device in FIG. 3 includes a fixing roller (heating roller) 21 having a heater 25 that heats the fixing roller 21 from inside and a pressure roller 22 that is arranged as a pressure member situated under the fixing roller 21 in parallel thereto and presses the fixing roller 21 from below by a spring with a predetermined.

The fixing roller 21 has a core metal 23 having a cylinder form made of aluminum, iron, etc. The surface of the core metal 23 is covered with a releasing resin layer 24 made of material such as PFA, PTFE, etc. A halogen heater (heating body) 25 is arranged inside the core metal 23 and a voltage is applied to the halogen heater 25. There is no specific limit to the method of manufacturing the fixing roller and the fixing roller can be manufactured according to any known methods.

A temperature detection element such as themistor is brought into contact with the fixing roller 21 to detect the temperature thereof and connected with a control device. The control device controls the supply power to the halogen heater according to the output signal from the themistor to maintain the temperature of the outer surface of the fixing roller 21 in a predetermined range.

The pressure roller 22 is arranged below the fixing roller 21 with both rotation axes in parallel to each other.

The pressure roller 22 includes a core metal 26 made of stainless steel, iron, etc., and an elastic member layer 27 covering the core metal 26. The elastic member layer 27 is formed of silicone rubber having excellent heat resistance and releasing property or a foam body such as fluorine rubber. The pressure roller 22 is arranged in contact with the fixing roller 21 and the surface layer thereof is formed of material having an excellent releasing property as in the case of the fixing roller 21.

The heating roller 21 and the pressure roller 22 form a nip portion N where the pressure roller 22 presses the fixing (heating) roller to nip a recording medium. The nip structure of the contact portion preferably is convex upward in FIG. 3 in terms of fixing separation property, thereby reducing the occurrence of winding of a recording medium S around the fixing roller 21 when a full color image is fixed.

When the recording medium S to which an unfixed toner image is transferred is conveyed to and passes through the nip portion N, the toner image T on the recording medium S is fixed upon application of heat by the fixing roller 21 functioning as a heating body, and pressure by the pair of the fixing roller 21 and pressure roller 22.

The fixing device for use in the present invention optionally includes a cleaning member to clean the fixing roller 21 and the pressure roller 22. There is no specific limit to such a cleaning device for the fixing roller 21 and the pressure roller 22 as long as the cleaning device meets the purpose of removing toner, transparent and colorless resin particulates or other contaminants on the fixing roller 21 and the pressure roller 22.

A specific example of the cleaning device to clean the fixing roller 21 is a cleaning wave in contact therewith. A specific example of the cleaning device to clean the pressure roller 22 is a cleaning roller in contact therewith.

In the present invention, when the pressure roller has a hardness of from 45 to 80° according to Asker C, high grade half tone images and images having high grade fine lines can be output by a combinational use of color toner and transparent and colorless particulates, which are described later. When a pressure roller that has an excessively small hardness is used, the pressure applied to the fixing nip portion tends to be insufficient, which causes the fixed image surface to be rough. Thereby, the obtained image tends to have insufficient gloss and a narrow range of color reproduction. To the contrary, when a pressure roller that has an excessively large hardness is used, the gloss of the obtained image tends to be uneven because the fixing nip width tends to be not sufficiently secured, which narrows the range of color reproduction.

When the pressure roller has a releasing layer preferably having a surface roughness Rz of from 0.05 to 3.0 μm and more preferably from 0.15 to 2.5 μm, the balance between the friction status between a recording medium that passes through the fixing device and a pressure roller and the pressure applied to the recording medium that passes through the fixing device is good, which improves the quality of the fixed image.

A preferable speed of the recording medium passing through the nip portion in the fixing process in the present invention is from 150 to 500 mm/sec. When the speed of the recording medium passing through the nip portion is too low, the heating time for the recording medium tends to be long so that transparent and colorless resin particulates described later may be excessively melted and thus adhered to the fixing member. When the speed of the recording medium passing through the nip portion is too high, the image may not be sufficiently fixed.

In addition, there is no specific limit to the method of controlling the surface roughness of the surface releasing layer of the pressure roller and the hardness thereof. Any known methods can be used as long as those satisfy the conditions specified above. For example, in a method of adjusting the surface roughness of the surface of the pressure roller, the surface of the pressure roller is covered with material such as PFA or PTFE having a sheet form which preliminarily has a surface roughness by using coarse particles or surface grinding. Alternatively, a method in which a pressure roller is formed by a resin foam manufactured while controlling the composition of the resin and the foaming method is suitably employed as the method of controlling the hardness of the pressure roller. Specific examples of the resins include, but are not limited to, silicone rubber, fluorine rubber, and melamine resins.

### Color Toner

The color toner for use in the present invention is formed of at least a binder resin and a coloring agent.

### Half Effusion Temperature of Color Toner

The color toner for use in the present invention is required to be relatively hardly transformed due to heating in comparison with typical color toner. The half effusion temperature (T1/2) of the color toner measured by a flow tester is 150° C. or higher, preferably 160° C. or higher and more preferably 170° C. or higher. When the half effusion temperature (T1/2) of the color toner measured by the flow tester is too low, the color toner tends to be transformed by the heat and pressure during fixing, which results in crush of the pointed portion of a color toner image and impregnation into a recording medium.

### Particle Diameter of Color Toner

The color toner preferably has a volume average particle diameter of from 2 to 8 μm and more preferably from 3 to 7 μm. When the volume average particle diameter is too small, Vander Waals' force tends to be dominant among the forces applied to the color toner so that the controlling the color toner electrostatically is difficult. When the volume average particle diameter is too large, forming fine images tends to be difficult.

### Form of Color Toner

The color toner for use in the present invention preferably has an average circularity of 0.950 or higher. In the present invention, the value obtained from the relationship (1) is defined as the circularity. This circularity is an indicator of the degree of roughness of toner particles. A toner particle having perfect round form has an indicator of 1.00 and the circularity decreases as the surface form of the toner particle is complex.

Circularity a=L₀/L relationship (1)

In the relationship (1), L₀ represents the circumferential length of a circle having an area equal to a projected area of a particle image and L represents the circumferential length of the projected area of the particle image.

Toner that has an average circularity of 0.95 or higher has a smooth surface and since the contact area between toner particles and between toner particles and the image bearing member is small, the toner has a good transferability.

Such toner particles do not have angles, the stirring torque of the development agent in the development device is small and thus the driving of stirring the development agent is stabilized so that no abnormal image is obtained.

There are no angled toner particles among the toner particles forming a dot. Therefore, when the toner particles are pressingly contacted with a transfer medium during the transfer process, the pressure is uniformly applied to the entire toner particle, so that hollow portions are hardly created during transfer. In addition, since the toner particles are not angled, the toner particles have a small grinding force so that the toner particles do not damage or abrade the surface of the image bearing member, a charging member, etc.

### Binder Resin

There is no specific limit to the resin for typical use in toner. Preferred specific examples of such resins include, but are not limited to, polyester resin, polyurethane resins, polyurea resins, epoxy resins, vinyl-based resins and hybrid resins in which at least two kinds of polymer units selected from these resin units are chemically bonded. Among these, polyester resins, vinyl-based resins, hybrid resins in which at least two kinds of polymer units selected from the polyester units and vinyl polymer units, and mixtures thereof.

### Coloring Agent

In the present invention, suitable coloring agents include any known dyes and pigments.

Specific examples of such coloring agents include carbon black, Nigrosine dyes, black iron oxide, Naphthol Yellow S, Hansa Yellow (10G, 5G and G), Cadmium Yellow, yellow iron oxide, loess, chrome yellow, Titan Yellow, polyazo yellow, Oil Yellow, Hansa Yellow (GR, A, RN and R), Pigment Yellow L, Benzidine Yellow (G and GR), Permanent Yellow (NCG), Vulcan Fast Yellow (5G and R), Tartrazine Lake, Quinoline Yellow Lake, Anthrazane Yellow BGL, isoindolinone yellow, red iron oxide, red lead, orange lead, cadmium red, cadmium mercury red, antimony orange, Permanent Red 4R, Para Red, Fire Red, p-chloro-o-nitroaniline red, Lithol Fast Scarlet G, Brilliant Fast Scarlet, Brilliant Carmine BS, Permanent Red (F2R, F4R, FRL, FRLL and F4RH), Fast Scarlet VD, Vulcan Fast Rubine B, Brilliant Scarlet G, Lithol Rubine GX, Permanent Red F5R, Brilliant Carmine 6B, Pigment Scarlet 3B, Bordeaux 5B, Toluidine Maroon, Permanent Bordeaux F2K, Helio Bordeaux BL, Bordeaux 10B, BON Maroon Light, BON Maroon Medium, Eosin Lake, Rhodamine Lake B, Rhodamine Lake Y, Alizarine Lake, Thioindigo Red B, Thioindigo Maroon, Oil Red, Quinacridone Red, Pyrazolone Red, polyazo red, Chrome Vermilion, Benzidine Orange, perynone orange, Oil Orange, cobalt blue, cerulean blue, Alkali Blue Lake, Peacock Blue Lake, Victoria Blue Lake, metal-free Phthalocyanine Blue, Phthalocyanine Blue, Fast Sky Blue, Indanthrene Blue (RS and BC), Indigo, ultramarine, Prussian blue, Anthraquinone Blue, Fast Violet B, Methyl Violet Lake, cobalt violet, manganese violet, dioxane violet, Anthraquinone Violet, Chrome Green, zinc green, chromium oxide, viridian, emerald green, Pigment Green B, Naphthol Green B, Green Gold, Acid Green Lake, Malachite Green Lake, Phthalocyanine Green, Anthraquinone Green, titanium oxide, zinc oxide, lithopone and the like. These materials can be used alone or in combination.

The content of the coloring agent is preferably from 1 to 15% by weight, and more preferably from 3 to 10% by weight, based on the total weight of the toner.

### Method of Manufacturing Color Toner

There is no specific limit to the method of manufacturing the color toner for use in the present invention. Any known methods such as wet granulation methods such as dissolution suspension methods, suspension polymerization methods, and emulsification agglomeration methods and pulverization methods can be suitably used.

### Dissolution Suspension Method

Toner can be manufactured by the dissolution suspension method as follows: dissolving or dispersing toner components containing at least a binder resin and a coloring agent in an organic solvent to obtain solution or liquid dispersion; dispersing the solution or the liquid dispersion in an aqueous medium under the presence of an inorganic dispersion agent or resin particulates using a typical stirrer, a homomixer, a homogenizer, etc., to obtain toner having a desired particle diameter distribution; and removing the organic solvent to obtain toner slurry. The obtained toner is retrieved by washing and filtration followed by drying for isolation according to any known method.

Using an organic solvent having a boiling point lower than 100° C. is preferable because such an organic solvent can be easily removed. Specific examples thereof include toluene, xylene, benzene, carbon tetrachloride, methylene chloride, 1,2-dichloroethane, 1,1,2-trichloroethane, trichloroethylene, chloroform, monochlorobenzene, dichloroethylidene, methyl acetate, ethyl acetate, methylethyl ketone, and methylisobutyl ketone. These can be used alone in combination.

Suitable aqueous media for use in the present invention include, but are not limited to, water, and mixtures of water with a solvent which can be mixed with water. Specific examples of such a solvent include, but are not limited to, methanol, isopropanol and ethylene glycol, dimethylformamide, tetrahydrofuran, cellosolves such as methyl cellosolve, lower ketones such as acetone and methyl ethyl ketone), etc. The amount of an aqueous medium is normally from 50 to 2,000 parts by weight and preferably from 100 to 1,000 parts by weight based on 100 parts by weight of a toner composition. When the amount of an aqueous medium is too small, the dispersion stability of a toner composition is degraded so that toner particles having a desired particle diameter are not obtained. An amount of an aqueous medium that is excessively large is not preferred in terms of economy.

Specific examples of the inorganic dispersion agents include, but are not limited to, tricalcium phosphate, magnesium phosphate, aluminum phosphate, zinc phosphate, magnesium carbonate, calcium hydroxide, magnesium hydroxide, aluminum hydroxide, calcium metasilicate, calcium sulfate, barium sulfate, bentonite, alumina, calcium carbonate, titanium oxide, colloidal silica, and hydroxyapatite.

There is no specific limit to the resin forming resin particulates as long as the resin forms an aqueous dispersion body. Specific examples thereof include, but are not limited to, vinyl based resins, polyurethane resins, epoxy resins, polyester resins, polyamide resins, polyimide resins, silicon based resins, phenol resins, melamine resins, urea resins, aniline resins, ionomer resins, and polycarbonate resins. These resins can be thermoplastic resins or thermocuring resins and can be used in combination. Among these, vinyl-based resins, polyurethane resins, epoxy resins and polyester resins and their combinational use are preferred in terms that an aqueous dispersion body having fine spherical resin particulates is easy to obtain.

In addition, as the toner composition, a prepolymer such as polyester is added during the toner manufacturing process to conduct addition polymerization reaction.

### Emulsification Agglomeration Method

A method in which toner slurry is obtained by agglomeration and/or adhesion of at least resin dispersion body with a coloring agent dispersion body, a wax dispersion body, etc. in a liquid medium is suitable as the method of manufacturing toner according to emulsification agglomeration. The toner is retrieved by washing and filtration and isolated by drying.

Specific examples of the liquid media include, but are not limited to, polar solvents such as water, lower alcohols such as methanol and ethanol, non-polar solvents such as tetrahydrofuran, and methylethyl ketone, and mixtures thereof. In terms of burden on the environment, and handling and control of dispersion and agglomeration of particles, water or a mixture of water and the lower alkyl is preferred.

The resins used as the binder resin can be used as the resins for the resin dispersion body. To obtain resin dispersion body from such a resin, a method of mechanically dispersing a preliminarily obtained resin as a polymer under the presence of an emulsification agent, or a method of polymerizing a monomer obtained as a precursor of a resin in a liquid medium can be used. Polymerization of the monomer in the liquid medium can be selected from addition polymerization by a vinyl-based monomer, a condensation polymerization of a polyol and polycarboxylic acid, a ring-opening polymerization of lactone or lactam, etc.

Specific examples of the vinyl-based monomers include, but are not limited to, styrene and derivatives thereof such as p-methylstyrene, p-styrene sulfonate, p-chlorostyrene, p-carboxystyrene, α-methylstyrene, and divinylbenzene; vinyl esters such as vinyl naphthalene, vinyl chloride, vinyl bromide, vinyl fluoride, vinyl acetate, vinyl propionate, vinyl benzoate, and vinyl butyrate, (meth)acrylic acid or esters thereof such as methyl(meth)acryalte, ethyl(meth)acryalte, propyl(meth)acryalte, isopropyl(meth)acryalte, butyl(meth)acryalte, t-butyl(meth)acryalte, hexyl(meth)acryalte, octyl(meth)acryalte, 2-ethylhexyl(meth)acryalte, decyl(meth)acryalte, dodecyl(meth)acryalte, stearyl(meth)acryalte, behenyl(meth)acryalte, 1,6-hexanediol diacrylate, and 1,10-decanedioldiacrylate; (meth)acrylamide such as N,—N-dimethyl(meth)acrylamide, N,N-diethyl(meth)acrylamide, and N,N-dibutyl(meth)acrylamide; maleic acid, maleic anhydride, monoesters of maleic acid, diesters of maleic acid, itaconic acid and esters thereof and other vinyl esters.

Radical generation agents can be suitably used to polymerize a vinyl-based monomer as a polymerization initiator. Specific examples thereof include, but are not limited to, water-soluble polymerization initiators such as ammonium persulfate, sodium persulfate, hydrogen peroxide, 4,4′-azobis(4-valeric acid) and salts thereof, 2,2′-azobis(2-amidinopropane) salts; azo-based, or diazo-based polymerization initiators such as 2,2′-azobis(2,4-dimethylvalerironitrile), 2,2′-azobis(isobutyronitrile), 1,1′-azobis(cyclohexane-1-carbonitrile), 2,2′-azobis(4-methoxy-2,4-dimethylvalerironitrile, and Azobis(isobutyronitrile); and oil-soluble polymerization initiators such as benzoyl peroxide, methylethylketone peroxide, diisopropyl peroxycarbonate, cumene hydroperoxide, 2,4-dichlorobenzoyl peroxide, and lauroyl peroxide.

Specific examples of the emulsification agents include, but are not limited to, anion emulsification agents such as sodium alkyl sulfonate, sodium alkyl benzene sulfonate, polyoxyethylene alkylether sodium sulfonate, sodium alkylnaphthalene sulfonate, sodium dialkylsulfo succinate, and sodium alkyldiphenyl ether disulfonate; nonion emulsification agents such as polyoxyethylene alkyl ether, polyoxyethylene alkenyl ether, polyoxypropyl alkyl ether, and sorbitan aliphatic acid esters; cation emulsification agents such as alkyltrimethyl ammonium chloride, and dialkyl dimethyl ammonium chloride; and amphoteric emulsification agents such as alkyl betaine. Among these, anion emulsification agents are preferred in terms of emulsification stability. In addition, amphoteric emulsification agents having both a hydrophilic group, and a polymerizable group is used to stabilize the dispersion status of the polymerized dispersion body.

### Suspension Polymerization Method

For example, a method of manufacturing toner according to the suspension polymerization method includes: adding a coloring agent, a polymerization initiator, and other additives to a monomer; dissolving or dispersing the monomer with a homogenizer, an ultrasonic dispersion machine, etc., to obtain uniform solution or liquid dispersion; and dispersing the solution or liquid dispersion in an aqueous medium containing a dispersion stabilizer with a typical stirrer, homomixer, homogenizer, etc. to conduct polymerization. The stirring speed and the time are adjusted for granulation such that monomer droplets have a preferable particulate diameter. Thereafter, stirring is conducted to maintain the particle status by the function of the dispersion stabilizer and avoid settling of the particles. The polymerization temperature is typically 40° C. or higher and preferably from 50 to 90° C. In addition, raising the temperature during the last half part of polymerization reaction is allowable. Furthermore, the aqueous medium is suitably distilled away during the last half part of the polymerization reaction or after the polymerization reaction to remove unreacted monomers or by-products which cause odor during fixing of toner. The obtained toner is retrieved by washing and filtration after the polymerization reaction followed by drying.

Specific examples of the dispersion stabilizers include, but are not limited to, inorganic compounds such as tricalcium phosphate, magnesium phosphate, aluminum phosphate, zinc phosphate, calcium carbonate, magnesium carbonate, calcium hydroxide, magnesium hydroxide, aluminum hydroxide, calcium methasilicate, calcium sulfonate, barium sulfonate, bentonite, silica and alumina; and organic compounds sodium salts of polyvinylalcohol, galatine, methylcellulose, methylhydroxypropyl cellulose, ethyl cellulose, or carboxy methylcellulose, polyacrylic acids and salts thereof, and starch. These can be used by dispersing them in an aqueous medium. The dispersion stabilizer is preferably added to a monomer in an amount of from 0.2 to 20% by weight. When an inorganic compound is used as the dispersion stabilizer, a market product can be used but inorganic particulates can be produced in the dispersion medium to obtain fine particles. For example, when tricalcium phosphate is used, sodium phosphate solution is mixed with calcium chloride solution.

### Pulverization Method

A method of manufacturing toner by a pulverization method is according to a known method and includes a process of mechanically mixing a toner component containing at least a binder resin and a coloring agent, a process of melting and kneading the resultant, a process of pulverizing the resultant, and a process of classifying the resultant. In addition, toner that is obtained from the processes other than the processes of pulverization and classification, which is different from toner products obtained from the processes of pulverization and classification, can be also recycled in the process of mechanical mixing or mixing and kneading.

The process of mechanical mixing is conducted by a mixer having a stirring wing under a typical condition. After this process, the mixture is placed in a kneading machine to melt and knead the mixture. One-axis and two axis continuous melting and kneading machines or batch type melting and kneading machines using a roll mill can be used. Specific examples thereof include, but are not limited to, a KTK type two axis extruder (manufactured by Kobe Steel Ltd.), a TEM type two axis extruder (manufactured by Toshiba Machine Co., Ltd.), a two axis extruder (manufactured by KCK Co., Ltd.), a PCM type two axis extruder (manufactured by Ikegai Co., Ltd.), and a co-kneader (manufactured by Buss Co., Ltd.). This melting and kneading process is performed under a condition set to be not sever the molecular chain of the binder resin. When the temperature of the melting and kneading is too low in comparison with the softening point of the binder resin, the molecular chain is easily severed. When the temperature of the melting and kneading is too high in comparison with the softening point of the binder resin, the coloring agent, etc. tend to be dispersed insufficiently. Therefore, the temperature of melting and kneading is suitably set depending on the softening point of the binder resin.

The mixture is pulverized after the process of melting and kneading. In the pulverization process, the mixture is preferably coarsely pulverized and then finely pulverized. A method of colliding particles (mixture) with a collision board in a jet air, a method of colliding particles with each other in a jet air, a method of pulverizing particles at a narrow gap between a stator and a rotor mechanically rotating are suitable as the pulverization method. Subsequent to the pulverization process, toner having a predetermined particle diameter is obtained by classifying the pulverized material with centrifugal force.

### Releasing Agent

The color toner for use in the present invention optionally includes a releasing agent (wax) to improve the releasing property between the fixing member and a fixing image during fixing.

Any known releasing agent can be used as the releasing agent in the present invention and specific examples thereof include, but are not limited to, polyolefin waxes such as polyethylene waxes and polypropylene waxes; long chain hydrocarbons such as paraffin waxes and SAZOL waxes; waxes including a carbonyl group, etc. Specific examples of the waxes including a carbonyl group include, but are not limited to, polyalkane acid esters such as carnauba wax, montan waxes, trimethylolpropane tribehenate, pentaerythritol tetrabehenate, pentaerythritol diacetate dibehenate, glycerin tribehenate, and 1,18-octadecanediol distearate; polyalkanol esters such as trimellitic acid tristearyl, and distearyl maleate; polyalkylamide such as trimellitic acid tristearylamide; dialkyl ketone such as distearyl ketone, etc. Among these materials, polyalkane acid esters are preferred.

The content of the releasing agent in the color toner for use in the present invention is 4% or lower, preferably 2% or lower, and more preferably 0%, meaning that the releasing agent is not added to the color toner but to the transparent and colorless resin particulates described later. This is because since the releasing agent is not compatible with the binder resin in the toner in terms of the original purpose of addition of the releasing agent and is thus dispersed in the toner as a domain, the light that enters into the inside of the toner is partially scattered due to the difference between the refraction indices of the binder resin and the releasing agent. Therefore, especially in the case of color toner, part of the absorbing light is reflected due to scattering so that sufficient image density is not easily secured. Thus, the content of the releasing agent is limited to the minimal amount.

### Transparent and Colorless Resin Particulates

The transparent and colorless resin particulates for use in the present invention is formed of at least a transparent and colorless resin.

### Transparent and Colorless Resin

Typical resins for toner can be used as the transparent and colorless resin and the binder resins specified above are suitably used.

Furthermore, using and selecting a binder resin having a skeleton similar to that of the resin forming the color toner is suitable to improve the binding property of the color toner and the transparent and colorless resin particulates during fixing. In addition, the refraction indices of the color toner and the transparent and colorless resin particulates are close to each other. Therefore, scattering at the interface of the color toner and the transparent and colorless resin particulates can be reduced. Therefore, not only is the fixing property improved but also images having a wide range of color representation are obtained.

To be more specific, 70% or more by weight of the binder resin for use in the color toner and 70% or more by weight of the transparent and colorless resin particulates have similar skeletons. In detail, 70% or more by weight of the binder resin for use in the color toner and 70% or more by weight of the transparent and colorless resin particulates are preferably polyester units or vinyl polymer units. For example, when the resin for use in the color toner is a polyester resin, i.e., a polyester unit occupies 100%, at least 70% by weight of the transparent and colorless resins forming the transparent and colorless resin particulates has preferably a polyester unit and more preferably all of them has a polyester unit.

### Polyester Unit

The polyester unit specified in the present invention represents, for example, a unit obtained by polymerization using, for example, dehydration reaction, dealcoholization reaction, ester exchange reaction between a polyol and a polycarboxylic acid, an anhydride thereof, or a low molecular weight alcohol, and a unit obtained by ring-opening polymerization of a lactone ring. The former is preferable in terms of the latitude of unit designing.

### Polyol

Specific examples of the polyols include, but are not limited to, alkylene glycol (e.g., ethylene glycol, 1,2-propylene glycol, 1,3-propylene glycol, 1,4-butanediol and 1,6-hexanediol); alkylene ether glycols (e.g., diethylene glycol, triethylene glycol, dipropylene glycol, polyethylene glycol, polypropylene glycol and polytetramethylene ether glycol); alicyclic diols (e.g., 1,4-cyclohexane dimethanol and hydrogenated bisphenol A); bisphenols (e.g., bisphenol A, bisphenol F, bisphenol 5 and 4,4′-dihydroxybiphenyls such as 3,3′-difluoro-4,4′-dihydroxybiphenyl); bis(hydroxyphenyl)alkanes (e.g., bis(3-fluoro-4-hydroxyphenyl)ethane, 2,2-bis(3-fluoro-4-hydroxyphenyl)propane, 2,2-bis(3,5-difluoro-4-hydroxyphenyl) propane (aka tetrafluoro bisphenol A) and 2,2-bis(3-hydroxyphenyl)-1,1,1,3,3,3-hexafluoro propane; adducts of the alicyclic diols mentioned above with an alkylene oxide (e.g., ethylene oxide, propylene oxide and butylene oxide); and adducts of the bisphenols mentioned above with an alkylene oxide (e.g., ethylene oxide, propylene oxide and butylene oxide); etc.

Among these compounds, alkylene glycols having from 2 to 12 carbon atoms and adducts of a bisphenol with an alkylene oxide are preferable. More preferably, adducts of a bisphenol with an alkylene oxide, or a mixture of an adduct of a bisphenol with an alkylene oxide and an alkylene glycol having from 2 to 12 carbon atoms are used. Furthermore, aliphatic alcohols having three or more hydroxyl groups (e.g., glycerin, trimethylol ethane, trimethylol propane, pentaerythritol and sorbitol); polyphenols having three or more hydroxyl groups (trisphenol PA, phenol novolak and cresol novolak); adducts of the polyphenols mentioned above with an alkylene oxide; etc. can be included. The polyols specified above can be used alone or in combination.

### Polycarboxylic Acid

Specific examples of the polycarboxylic acids include, but are not limited to, alkylene dicarboxylic acids (e.g., succinic acid, adipic acid and sebacic acid); alkenylene dicarboxylic acids (e.g., maleic acid and fumaric acid); aromatic dicarboxylic acids (e.g., phthalic acid, isophthalic acid, terephthalic acid and naphthalene dicarboxylic acids, 3-fluoroisophtalic acid, 2-fluoroisophthalic acid, 2-fluoroterephthalic acid, 2,4,5,6-tetrafluoroisophthalic acid, 2,3,5,6-tetrafluoroterephthalic acid, 5-trifluoromethyl isophthalic acid, 2,2-bis(4-carboxyphenyl)hexafluoropropane, 2,2-bis(3-carboxyphenyl)hexafluoropropane, 2,2-bis(trifluoromethyl)-4,4,-biphenyl dicarboxylic acid, 3,3′-bis(trifluoromethyl-4,4′-biphenyl dicarboxylic acid, 2,2-bis(trifluoromethyl)-3,3-biphenyl dicarboxylic acid, and an anhydride of hexafluoro isopropylidene diphthalic acid; etc.

Among these compounds, alkenylene dicarboxylic acids having 4 to 20 carbon atoms and aromatic dicarboxylic acids having 8 to 20 carbon atoms are preferably used.

Specific examples of the polycarboxylic acids having three or more hydroxyl groups include, but are not limited to, aromatic polycarboxylic acids having 9 to 20 carbon atoms (e.g., trimellitic acid and pyromellitic acid).

Also, resultants of reaction between an anhydride or lower alkyl esters (e.g., methyl esters, ethyl esters or isopropyl esters) of the polycarboxylic acids mentioned above and the polyol specified above can be used. These polycarboxylic acids specified above can be used alone or in combination.

### Vinyl Polymer Unit

The vinyl polymer unit represented in the present invention is a unit obtained by addition polymerization by a vinyl-based monomer.

Specific examples of the vinyl-based monomers include, but are not limited to, styrene and derivatives thereof such as p-methylstyrene, p-styrene sulfuric acid, p-chlorostyrene, p-carboxystyrene, α-methylstyrene, and divinylbenzene, vinyl esters such as vinylnaphthalene, vinyl chloride, vinyl bromide, vinyl fluoride, vinyl acetate, vinyl propionate, vinyl benzoate, and vinyl butyrate, (meth)acrylic acid or esters thereof such as methyl(meth)acryalte, ethyl(meth)acryalte, propyl(meth)acryalte, isopropyl(meth)acryalte, butyl(meth)acryalte, t-butyl(meth)acryalte, hexyl(meth)acryalte, octyl(meth)acryalte, 2-ethylhexyl(meth)acryalte, decyl(meth)acryalte, dodecyl(meth)acryalte, stearyl(meth)acryalte, behenyl(meth)acryalte, 1,6-hexanediol diacrylate, and 1,10-decanedioldiacrylate; (meth)acrylamide such as N,—N-dimethyl(meth)acrylamide, N,N-diethyl(meth)acrylamide, and N,N-dibutyl(meth)acrylamide; maleic acid, maleic anhydride, monoesters of maleic acid, diesters of maleic acid, itaconic acid and esters thereof and other vinyl esters. These can be used alone or in combination.

Radical generation agents can be suitably used to polymerize a vinyl-based monomer as a polymerization initiator. Specific examples thereof include, but are not limited to, water-soluble polymerization initiators such as ammonium persulfate, sodium persulfate, hydrogen peroxide, 4,4′-azobis(4-valeric acid) and salts thereof, 2,2′-azobis(2-amidinopropane) salts; azo-based, or diazo-based polymerization initiators such as 2,2′-azobis(2,4-dimethylvalerironitrile), 2,2′-azobis(isobutyronitrile), 1,1′-azobis(cyclohexane-1-carbonitrile), 2,2′-azobis(4-methoxy-2,4-dimethylvalerironitrile, and Azobis(isobutyronitrile); and oil-soluble polymerization initiators such as benzoyl peroxide, methylethylketone peroxide, diisopropyl peroxycarbonate, cumene hydroperoxide, 2,4-dichlorobenzoyl peroxide, and lauroyl peroxide.

### Method of Manufacturing Transparent and Colorless Resin Particulate

There is no specific limit to the method of manufacturing transparent and colorless resin particulates for use in the present invention and any known wet granulation methods such as a dissolution suspension method, a suspension polymerization method and an emulsification agglomeration method and pulverization methods can be used. The transparent and colorless resin particulates can be manufactured by the same method described above except that the coloring agent is not contained.

### Half Effusion Temperature of Transparent and Colorless Resin Particulates

The transparent and colorless resin particulates for use in the present invention is melted upon application of heat and pressure during fixing, adhered to the color toner in a wet manner, and impregnated or adhered to a recording medium such as paper to have a smooth surface. To be specific, the half effusion temperature (T1/2) measured by a flow tester is 130° C. or lower, and preferably 120° or lower. When the half effusion temperature is too high, the transparent and colorless resin particulates tend to be not sufficiently transformed. Therefore, adhesion of the transparent and colorless resin particulates with the color toner and/or impregnation or adhesion of the transparent and colorless resin particulates with a recording medium such as paper is insufficient, thereby causing the fixing intensity to be insufficient. In addition, the surface smoothness is also insufficient so that the entire image is whitish, which is not preferred.

### Releasing Agent (Wax) of Transparent and Colorless Resin Particulate

The transparent and colorless resin particulates for use in the present invention optionally includes a releasing agent (wax) to improve the releasing property between the fixing member and a fixing image during fixing.

Specifically, the releasing agents specified for the color toner are suitable and the long-chain hyrdrocarbon is preferably used. The content of the releasing agent for use in the transparent and colorless resin particulates is from 2 to 40% by weight, and preferably from 3 to 15% by weight based on the entire content of the transparent and colorless resin particulates. When the content is too small, the releasing effect is not sufficiently demonstrated. When the content is too large, the toughness of the transparent and colorless resin particulates tends to be low, thereby causing the degree of handling difficulty of the transparent and colorless resin particulates to be high in the processes. For example, the transparent and colorless resin particulates adhere to the image bearing member.

### Charge Control Agent and External Additive

Both the color toner and the transparent and colorless resin particulates optionally include a charge control agent to preferably control the chargeability of particles.

Specific examples of the charge control agent include known charge control agents, for example, Nigrosine dyes, triphenylmethane dyes, metal complex dyes including chromium, chelate compounds of molybdic acid, Rhodamine dyes, alkoxyamines, quaternary ammonium salts (including fluorine-modified quaternary ammonium salts), alkylamides, phosphor and compounds including phosphor, tungsten and compounds including tungsten, fluorine-containing activators, metal salts of salicylic acid, metal salts of salicylic acid derivatives, etc. Specific examples of the marketed products of the charge control agents include, but are not limited to, BONTRON 03 (Nigrosine dyes), BONTRON P-51 (quaternary ammonium salt), BONTRON S-34 (metal-containing azo dye), E-82 (metal complex of oxynaphthoic acid), E-84 (metal complex of salicylic acid), and E-89 (phenolic condensation product), which are manufactured by Orient Chemical Industries Co., Ltd.; TP-302 and TP-415 (molybdenum complex of quaternary ammonium salt), which are manufactured by Hodogaya Chemical Co., Ltd.; COPY CHARGE PSY VP2038 (quaternary ammonium salt), COPY BLUE (triphenyl methane derivative), COPY CHARGE NEG VP2036 and NX VP434 (quaternary ammonium salt), which are manufactured by Hoechst AG; LRA-901, and LR-147 (boron complex), which are manufactured by Japan Carlit Co., Ltd.; copper phthalocyanine, perylene, quinacridone, azo pigments and polymers having a functional group, for example, a sulfonate group, a carboxyl group and a quaternary ammonium salt.

In addition, known organic particulates and particulate polymers are preferably used as an external additive to assist fluidity, developability, and chargeability of the color toner and the transparent and colorless resin particulates obtained in the present invention. Such an external additive preferably has a primary particle diameter of from 5 nm to 2 μm and particularly preferably from 5 nm to 500 nm. Furthermore, the specific surface area according to BET method is preferably from 20 to 500 m²/g. The usage ratio of the external additive is preferably from 0.01 to 5% by weight and particularly preferably from 0.01 to 2.0% by weight based on toner.

Specific examples of such inorganic particulates include, but are not limited to, silica, alumina, titanium oxide, barium titanate, magnesium titanate, calcium titanate, strontium titanate, zinc oxide, tin oxide, quartz sand, clay, mica, sand-lime, diatom earth, chromium oxide, cerium oxide, red iron oxide, antimony trioxide, magnesium oxide, zirconium oxide, barium sulfate, barium carbonate, calcium carbonate, silicon carbide, and silicon nitride.

As other fluidizers, there can be used polymeric particulates, for example, copolymers of styrene, esters of methacryic acid, and esters of acrylic acid, which can be prepared by a soap-free emulsion polymerization method, a suspension polymerization method or a dispersion polymerization method, and polycondensation thermosetting resins, for example, silicone resins, benzoguanamine resins and nylon.

Such fluidizers can be subject to a surface treatment to improve hydrophobic property, thereby preventing deterioration of the fluidity and charging properties of a toner even in a high humid environment. Specific preferred examples of the surface preparation agents include, but are not limited to, silane coupling agents, silylation agents, silane coupling agents including a fluoroalkyl group, organic titanate coupling agents, aluminum coupling agents, silicone oil, and modified silicone oils.

### Measuring Method

### Surface Roughness of Releasing Layer Forming Surface of Pressure Roller

The surface roughness of releasing layer forming surface of pressure roller is measured by using a surface roughness measuring instrument (SE3500, manufactured by Kosaka Laboratory Ltd.) under the following conditions:

### Temperature: 24° C.

### Humidity: 60%

Cut off length: 0.08 mm
Measuring length: 2.5 mm
Drive speed: 0.1 mm/sec.

### Hardness of Pressure Roller

The hardness of the pressure roller is measured by ASLER C type rubber hardness measuring instrument (manufactured by Kobunshi Keiki Co., Ltd.) under the environment of 24° C. and 60%. In the hardness measuring by ASKER C type rubber hardness, a half sphere indenter having a diameter of 5.08 mm is pressed fit into the pressure roller under a load of 1 kg.

### Method of Measuring Half Effusion Temperature by Flow Tester

The half effusion temperature (T1/2) by a flow tester in the present invention is measured by a high elevated flow tester (CFT 500D, manufactured by Shimadzu Corporation).

Toner which has been preliminarily adjusted at 24° C. and 50% RH for 24 hours is prepared. 1.0 g of the toner is weighed and pressed for 30 seconds under a load of 4 kN by using a forming machine.

The thus obtained press-formed sample is set in the environment (temperature: 20 to 24° C. and humidity: 30 to 70% RH) in a flow tester CFT-500D preliminarily set at 40° C. After 200 seconds for preheating, a load of 30 kgf is applied to the sample and the measuring is performed according to the temperature elevation method at a temperature elevation speed of 3° C. per minute with a die diameter of 0.5 mm and a die length of 1.0 mm.

An S-letter curve of the falling amount (flow value) of the plunger-temperature is drawn and when the height of the curve is defined to be h, the temperature corresponding to h/2 (i.e., temperature at which a half of the toner has effused) is the half effusion temperature.

### Volume Average Particle Diameter

The volume average particle diameter is measured by Coulter Counter method. Coulter Counter TA-II or Coulter Multisizer II (both are manufactured by Beckman Coulter Co., Ltd.) can be used as the measuring device. The measuring method is as follows: Add 0.1 to 5 ml of a surface active agent, preferably a salt of an alkyl benzene sulfonate, as a dispersant to 100 to 150 ml of an electrolytic aqueous solution, which is about 1% NaCl aqueous solution prepared by using primary NaCl and pure water, for example, ISOTON-II (manufactured by Beckman Coulter, Inc.) can be used; add 2 to 20 mg of a toner as a measuring sample to the electrolytic aqueous solution; Conduct dispersion treatment for the electrolytic aqueous solution in which the measuring sample is dispersed for about 1 to 3 minutes by a supersonic dispersion device; Measure the volume and the number of the toner particles or the toner by Coulter Counter with an aperture of 100 μm; and calculate the volume distribution and the number distribution. The weight average particle diameter and the number average particle diameter of the toner can be obtained based on the obtained distributions.

The whole range is a particle diameter of from 2.00 to smaller than 40.30 μm and the number of the channels is 13. Each channel is: from 2.00 to not greater than 2.52 μm; from 2.52 to not greater than 3.17 μm; from 3.17 to not greater than 4.00 μm; from 4.00 to not greater than 5.04 μm; from 5.04 to not greater than 6.35 μm; from 6.35 to not greater than 8.00 μm; from 8.00 to not greater than 10.08 μm; from 10.08 to not greater than 12.70 μm; from 12.70 to not greater than 16.00 μm, from 16.00 to not greater than 20.20 μm; from 20.20 to not greater than 25.40 μm; from 25.40 to not greater than 32.00 μm; and from 32.00 to not greater than 40.30 μm.

### Average Circularity

The circularity is measured by using a flow type particle image analyzer (FPIA-2100, manufactured by Sysmex Corporation). The specific procedure to obtain the average circularity is as follows:
1) A surface active agent serving as a dispersion agent, preferably 0.1 to 5 ml of an alkylbenzenesulfonic acid salt, is added to 100 to 150 ml of water from which solid impurities have been preliminarily removed;
2) About 0.1 to 0.5 g of a sample to be measured is added into the mixture prepared in (1);
3) The mixture prepared in (2) is subjected to an ultrasonic dispersion treatment for about 1 to 3 minutes such that the concentration of the particles is 3,000 to 10,000 particles per microlitter; and
4) The form and average particle diameter distribution of the sample are measured by the instrument mentioned above.

Having generally described preferred embodiments of this invention, further understanding can be obtained by reference to certain specific examples which are provided herein for the purpose of illustration only and are not intended to be limiting. In the descriptions in the following examples, the numbers represent weight ratios in parts, unless otherwise specified.

### EXAMPLES

### Synthesis of Polyester 1

The following components are contained in a reaction container equipped with a condenser, stirrer and a nitrogen introducing tube to conduct a reaction at 230° C. for 9 hours followed by another reaction with a reduced pressure of 10 to 18 mmHg for 6 hours:

| | |
|---|---|
| Adduct of bisphenol A with 2 mol of ethylene oxide | 241 parts |
| Bisphenol A with 2 mole of propylene oxide | 514 parts |
| Terephthalic acid | 106 parts |
| Isophthalic acid | 102 parts |
| Adipic acid | 46 parts |
| Dibutyl tin oxide | 2 parts |

41 parts of trimellitic anhydride are added in the container to conduct a reaction at 180° C. under normal pressure for 2 hours to obtain [Polyester 1]. The number average molecular weight of the obtained [Polyester 1] is 2,600, the weight average molecular weight thereof is 7,100, and the acid value thereof is 22 mgKOH/g.

### Synthesis of Polyester 2

The following components are contained in a reaction container equipped with a condenser, stirrer and a nitrogen introducing tube to conduct a reaction at 230° C. for 8 hours followed by another reaction with a reduced pressure of 10 to 18 mmHg for 6 hours:

| | |
|---|---|
| Adduct of bisphenol A with 2 mol of ethylene oxide | 218 parts |
| Bisphenol A with 2 mole of propylene oxide | 460 parts |
| Terephthalic acid | 140 parts |
| Isophthalic acid | 145 parts |
| Dibutyl tin oxide | 2 parts |

24 parts of trimellitic anhydride are added in the container to conduct a reaction at 180° C. under normal pressure for 2 hours to obtain [Polyester 2]. The number average molecular weight of the obtained [Polyester 2] is 7,600, the weight average molecular weight thereof is 2,100, and the acid value thereof is 15 mgKOH/g.

### Synthesis of Styrene-Acryl Resin 1

510 parts of toluene are placed in a reaction container equipped with a condenser, a stirrer and a nitrogen introducing tube and the air in the reaction container is replaced with nitrogen gas. 545 parts of styrene, 148 parts of n-butylacrylate, 41 parts of methacrylic acid and 5 parts of benzoyl peroxide functioning as a polymerization initiator are dissolved to obtain a solvent mixture while stirred under reflux of the toluene and the solvent mixture is dropped to the reaction container in 2.5 hours. Thereafter, the resultant is stirred and aged for one hour at a temperature at which the toluene evaporates to conduct solution polymerization. Thereafter, the temperature of the system is gradually raised to 180° C. and the toluene is removed under a reduced pressure to obtain a polymerization body. The polymerization body is cooled down and pulverized to obtain [Styrene acryl resin 1]. The obtained [Styrene acryl resin 1] has a number average molecular weight of 7,200 and a weight average molecular weight of 16,000, and an acid value of 36 mgKOH/g.

### Synthesis of Prepolymer

The following components are contained in a container equipped with a condenser, a stirrer and a nitrogen introducing tube to conduct a reaction at 230° C. at normal pressure for 8 hours followed by another reaction for 5 hours with a reduced pressure of 10 to 15 mmHg to obtain [Intermediate body polyester 1]:

| | |
|---|---|
| Adduct of bisphenol A with 2 mole of ethylene oxide | 682 parts |
| Adduct of bisphenol A with 2 mole of propylene oxide | 81 parts |
| Terephthalic acid | 283 parts |
| Trimellitic anhydrate | 22 parts |
| Dibutyl tin oxide | 2 parts |

The obtained [Intermediate body polyester 1] has a number average molecular weight of 2,100, a weight average molecular weight of 9,500, a glass transition temperature of 55° C., an acid value of 0.5 mgKOH/g and a hydroxyl value of 49 mgKOH/g.

Next, the following components are contained in a container equipped with a condenser, a stirrer and a nitrogen introducing tube to conduct a reaction at 100° C. for 5 hours to obtain [Prepolymer 1]:

| | |
|---|---|
| Intermediate body polyester 1 | 411 parts |
| Isophorone diisocyanate | 89 parts |
| Ethyl acetate | 500 parts |

[Prepolymer 1] has an isolated isocyanate weight % of 1.53%.

### Method of Manufacturing Color Toner 1

### Master Batch 1

The following is mixed by a HENSCHEL MIXER to obtain a mixture in which water is soaked in a pigment agglomeration body.

| | |
|---|---|
| Pigment blue 15:3 | 45 parts |
| Polyester 1 | 55 parts |
| Water | 30 parts |

The mixture is mixed and kneaded for 45 minutes by a two-roll with a surface temperature of the rolls of 130° C. The resultant is pulverized by a pulverizer to a size of 1 mm to obtain [Master batch 1].

### Manufacturing of Liquid Dispersion (Oil Phase) of Pigment and Wax

The following is placed and mixed in a reaction container equipped with a stirrer and a thermometer:

| | |
|---|---|
| Polyester 1 | 545 parts |
| Paraffin wax (HNP-9, manufactured by | 44 parts |
| Nippon Seiro Co., Ltd.) | |
| Ethyl acetate | 1,450 parts |

The mixture is agitated, heated to 80° C., and kept at 80° C. for 5 hours and then cooled down to 30° C. in 1 hour. Then, 320 parts of [Master batch 1] and 100 parts of ethyl acetate are added to the reaction container and mixed for 1 hour to obtain [Liquid material 1].

Then, 1,500 parts of [Liquid material 1] is transferred to a reaction container and dispersed using a bead mill (ULTRAVISCOMILL from AIMEX) under the following conditions to disperse the pigment and the wax:

Liquid feeding speed: 1 kg/hr,

Disc rotation speed: 6 m/sec,

Diameter of zirconia beads: 0.5 mm,

Filling factor: 80% by volume, and

Repeat number of dispersion treatment: 3 times.

Next, 660 parts of 70% by weight of ethyl acetic acid solution of [Polyester 1] and 100 parts of ethyl acetate are added to the container. After 1 pass of the beadmill under the condition specified above, [Pigment wax liquid dispersion 1] is obtained. Ethyl acetate is added to adjust the density of the solid portion (at 130° C. for 30 minutes) of [Pigment wax liquid dispersion 1] to be 50%.

Preparation of Aqueous Phase 970 parts of deionized water, 40 parts of a 25% aqueous solution of organic resin particulates (Copolymer of sodium salt of an adduct of sulfate with styrene-methacrylic acid-acrylic butylate-ethylene oxide methacrylate) for dispersion stability, 140 parts of a 48.5% aqueous solution of dodecyldiphenylether sodium disulfonate, and 90 parts of ethyl acetate are mixed and stirred to obtain [Aqueous phase 1]

### Emulsification Process

975 parts of [Pigment wax liquid dispersion 1] and 7.5 parts of isophorone diamine are mixed by a TK HOMOMIXER (manufactured by Tokushu Kika Kogyo Co., Ltd.) for one minute at a rotation of 5,000 rpm. 288 parts of [Prepolymer 1] is added followed by mixing by the TK HOMOMIXER for one minute at a rotation of 7,000 rpm. Then, 1,200 parts of [Aqueous phase 1] are added thereto followed by mixing by the TK HOMOMIXER for 20 minutes while controlling the rotation range thereof from 8,000 to 13,000 rpm. Thus, [Emulsion slurry 1] is prepared.

[Emulsion slurry 1] is set in a container equipped with a stirrer and a thermometer, and heated at 30° C. for 8 hours to remove the solvents therefrom. Subsequent to aging at 45° C. for 4 hours, [Slurry dispersion 1] is obtained.

### Washing and Drying

100 parts of [Emulsion slurry 1] are filtered under a reduced pressure. Then, the following operations are performed.
(1) 100 parts of deionized water are added to the thus prepared filtered cake and the mixture is mixed by a TK HOMOMIXER for 10 minutes at a rotation of 12,000 rpm followed by filtration;
(2) 100 parts of 10% sodium hydroxide are added to the filtered cake prepared in (1) and the resultant is mixed by a TK HOMOMIXER for 30 minutes at a rotation of 12,000 rpm while applying supersonic vibration thereto, and then filtered under a reduced pressure. This ultrasonic wave alkali washing is repeated again (i.e.; ultrasonic wave alkali washing is performed twice);
(3) 10% hydrochloric acid is added to the filtered cake obtained in (2) and the filtered cake is mixed by the TK HOMOMIXER for 10 minutes at a rotation of 12,000 rpm and filtration; and
(4) 300 parts of deionized water are added to the filtered cake prepared in (3) and the resultant is mixed by the TK HOMOMIXER for 10 minutes at a rotation of 12,000 rpm followed by filtration.

This operation is repeated twice to obtain [Filtered cake 1].

[Filtered cake 1] is dried at 45° C. for 48 hours using a circulating drier. The dried cake is sieved using a screen having openings of 75 μm. Thus, [Mother toner 1] is obtained. The volume average particle diameter (Dv) is 5.6 μm, the number average particle diameter (Dp) is 5.0 μm, Dv/Dp is 1.12, and the average circularity is 0.966. Next, 0.5 parts of hydrophobic silica and 0.5 parts of hydrophobic titanium oxide are admixed with 100 parts of this Mother toner using a HENSCHEL MIXER to obtain [Color toner 1]. The half effusion temperature of [Color Toner 1] is 159° C.

### Method of Manufacturing Color Toner 2

### Preparation of Aqueous Phase

995 parts of deionized water, 35 parts of a 25% aqueous solution of organic resin particulates (Copolymer of sodium salt of an adduct of sulfate with styrene-methacrylic acid-acrylic butylate-ethylene oxide methacrylate) for dispersion stability, 120 parts of a 48.5% aqueous solution of dodecyldiphenylether sodium disulfonate, and 90 parts of ethyl acetate are mixed and stirred to obtain [Aqueous phase 2].

### Emulsification Process

975 parts of [Pigment wax liquid dispersion 1] and 7.5 parts of isophorone diamine are mixed by a TK HOMOMIXER (manufactured by Tokushu Kika Kogyo Co., Ltd.) for one minute at a rotation of 5,000 rpm. 288 parts of [Prepolymer 1] is added followed by mixing by the TK HOMOMIXER for one minute at a rotation of 7,000 rpm. Then, 1,200 parts of [Aqueous phase 2] are added thereto followed by mixing by the TK HOMOMIXER for 20 minutes while controlling the rotation range thereof from 8,000 to 13,000 rpm. Thus, [Emulsion slurry 2] is prepared.

[Emulsion slurry 2] is set in a container equipped with a stirrer and a thermometer, and heated at 30° C. for 8 hours to remove the solvents therefrom. Subsequent to aging at 45° C. for 4 hours, [Slurry dispersion 2] is obtained.

### Washing and Drying

100 parts of [Emulsion slurry 2] are filtered under a reduced pressure. Then, the following operations are performed.
(1) 100 parts of deionized water are added to the thus prepared filtered cake and the mixture is mixed by a TK HOMOMIXER for 10 minutes at a rotation of 12,000 rpm followed by filtration;
(2) 100 parts of 10% sodium hydroxide are added to the filtered cake prepared in (1) and the resultant is mixed by a TK HOMOMIXER for 30 minutes at a rotation of 12,000 rpm while applying supersonic vibration thereto, and then filtered under a reduced pressure. This ultrasonic wave alkali washing is repeated again (ultrasonic wave alkali washing is performed twice);
(3) 10% hydrochloric acid is added to the filtered cake obtained in (2) and the filtered cake is mixed by the TK HOMOMIXER for 10 minutes at a rotation of 12,000 rpm and filtration; and
(4) 300 parts of deionized water are added to the filtered cake prepared in (3) and the resultant is mixed by the TK HOMOMIXER for 10 minutes at a rotation of 12,000 rpm followed by filtration. This operation is repeated twice to obtain [Filtered cake 2].

[Filtered cake 2] is dried at 45° C. for 48 hours using a circulating drier. The dried cake is sieved using a screen having openings of 75 μm. Thus, [Mother toner 2] is obtained. The volume average particle diameter (Dv) is 8.8 μm, and the average circularity is 0.958. Next, 0.4 parts of hydrophobic silica and 0.4 parts of hydrophobic titanium oxide are admixed with 100 parts of this Mother toner by a HENSCHEL MIXER to obtain [Color toner 2]. The half effusion temperature of [Color Toner 2] is 160° C.

### Method of Manufacturing Color Toner 3

### Preparation of Aqueous Phase

995 parts of deionized water, 35 parts of a 25% aqueous solution of organic resin particulates (Copolymer of sodium salt of an adduct of sulfate with styrene-methacrylic acid-acrylic butylate-ethylene oxide methacrylate) for dispersion stability, 120 parts of a 48.5% aqueous solution of dodecyldiphenylether sodium disulfonate, and 90 parts of ethyl acetate are mixed and stirred to obtain [Aqueous phase 2].

### Emulsification Process

975 parts of [Pigment wax liquid dispersion 1] and 7.5 parts of isophorone diamine are mixed by a TK HOMOMIXER (manufactured by Tokushu Kika Kogyo Co., Ltd.) for one minute at a rotation of 5,000 rpm. 288 parts of [Prepolymer 1] are added followed by mixing by the TK HOMOMIXER for one minute at a rotation of 7,000 rpm. Then, 1,200 parts of [Aqueous phase 2] are added thereto followed by mixing by the TK HOMOMIXER for 20 minutes while controlling the rotation range thereof from 8,000 to 13,000 rpm. Thus, [Emulsion slurry 2] is prepared.

9,500 parts of deionized water is set in a container equipped with a stirrer and a thermometer, and [Emulsion slurry 2] is set therein while stirring. Then, the solvents are removed at 30° C. in 12 hours followed by aging at 40° C. for 6 hours, [Dispersion slurry 3] is obtained.

### Washing and Drying

100 parts of [Dispersion slurry 3] are filtered under a reduced pressure. Then, the following operations are performed.
(1) 100 parts of deionized water are added to the thus prepared filtered cake and the mixture is mixed by a TK HOMOMIXER for 10 minutes at a rotation of 12,000 rpm followed by filtration;
(2) 100 parts of 10% sodium hydroxide are added to the filtered cake prepared in (1) and the resultant is mixed by a TK HOMOMIXER for 30 minutes at a rotation of 12,000 rpm while applying supersonic vibration thereto, and then filtered under a reduced pressure. This ultrasonic wave alkali washing is repeated again (ultrasonic wave alkali washing is performed twice);
(3) 10% hydrochloric acid is added to the filtered cake obtained in (2) and the filtered cake is mixed by the TK HOMOMIXER for 10 minutes at a rotation of 12,000 rpm and filtration; and
(4) 300 parts of deionized water are added to the filtered cake prepared in (3) and the resultant is mixed by the TK HOMOMIXER for 10 minutes at a rotation of 12,000 rpm followed by filtration. This operation is repeated twice to obtain [Filtered cake 2].

[Filtered cake 3] is dried at 45° C. for 48 hours using a circulating drier. The dried cake is sieved using a screen having openings of 75 μm. Thus, [Mother toner 3] is obtained. The volume average particle diameter (Dv) is 9.1 μm, and the average circularity is 0.941. Next, 0.4 parts of hydrophobic silica and 0.4 parts of hydrophobic titanium oxide are admixed with 100 parts of this Mother toner by a HENSCHEL MIXER to obtain [Color toner 3]. The half effusion temperature of [Color Toner 3] is 158° C.

### Method of Manufacturing Color Toner 4

### Manufacturing of Liquid Dispersion (Oil Phase) of Pigment and Wax

The following is placed and mixed in a reaction container equipped with a stirrer and a thermometer:

| | |
|---|---|
| Polyester 1 | 540 parts |
| Ethyl acetate | 1,450 parts |

The mixture is agitated, heated to 80° C., and kept at 80° C. for 5 hours and then cooled down to 30° C. in 1 hour. Then, 310 parts of [Master batch 1] and 100 parts of ethyl acetate are added to the reaction container and mixed for 1 hour to obtain [Liquid material 2].

Then, 1,350 parts of [Liquid material 2] is transferred to a reaction container and dispersed using a bead mill (ULTRAVISCOMILL from AIMEX) under the following conditions to disperse the pigment and the wax:

Liquid feeding speed: 1 kg/hr,

Disc rotation speed: 6 m/sec,

Diameter of zirconia beads: 0.5 mm,

Filling factor: 80% by volume, and

Repeat number of dispersion treatment: 3 times.

Next, 605 parts of 70% by weight of ethyl acetic acid solution of [Polyester 1] and 100 parts of ethyl acetate are added to the container. After 1 pass of the bead mill under the condition specified above, [Pigment wax liquid dispersion 2] is obtained. Ethyl acetate is added to adjust the density of the solid portion (at 130° C. for 30 minutes) of [Pigment wax liquid dispersion 2] to be 50%.

### Preparation of Aqueous Phase

995 parts of deionized water, 35 parts of a 25% aqueous solution of organic resin particulates (Copolymer of sodium salt of an adduct of sulfate with styrene-methacrylic acid-acrylic butylate-ethylene oxide methacrylate) for dispersion stability, 120 parts of a 48.5% aqueous solution of dodecyldiphenylether sodium disulfonate, and 90 parts of ethyl acetate are mixed and stirred to obtain [Aqueous phase 4].

### Emulsification Process

975 parts of [Pigment wax liquid dispersion 4] and 7.7 parts of isophorone diamine are mixed by a TK HOMOMIXER (manufactured by Tokushu Kika Kogyo Co., Ltd.) for one minute at a rotation of 5,000 rpm. 297 parts of [Prepolymer 1] is added followed by mixing by the TK HOMOMIXER for one minute at a rotation of 7,000 rpm. Then, 1,200 parts of [Aqueous phase 4] are added thereto followed by mixing by the TK HOMOMIXER for 20 minutes while controlling the rotation range thereof from 8,000 to 13,000 rpm. Thus, [Emulsion slurry 4] is prepared.

Thereafter, [Color toner 4] is obtained in the same manner as in the case of [Color toner 1] and has a volume average particle diameter (Dv) of 5.8 μm, an average circularity of 0.961 and a half effusion temperature of 162° C.

### Method of Manufacturing Color Toner 5

### Manufacturing of Liquid Dispersion (Oil Phase) of Pigment and Wax

The following is placed and mixed in a reaction container equipped with a stirrer and a thermometer:

| | |
|---|---|
| Polyester 1 | 520 parts |
| Paraffin wax (HNP-9, manufactured by | 135 parts |
| Nippon Seiro Co., Ltd.) | |
| Ethyl acetate | 1,450 parts |

The mixture is agitated, heated to 80° C., and kept at 80° C. for 5 hours and then cooled down to 30° C. in 1 hour. Then, 310 parts of [Master batch 1] and 100 parts of ethyl acetate are added to the reaction container and mixed for 1 hour to obtain [Liquid material 3].

Then, 1,500 parts of [Liquid material 3] is transferred to a reaction container and dispersed using a bead mill (ULTRAVISCOMILL from AIMEX) under the following conditions to disperse the pigment and the wax:

Liquid feeding speed: 1 kg/hr,

Disc rotation speed: 6 m/sec,

Diameter of zirconia beads: 0.5 mm,

Filling factor: 80% by volume, and

Repeat number of dispersion treatment: 3 times.

Next, 570 parts of 70% by weight of ethyl acetic acid solution of [Polyester 1] and 100 parts of ethyl acetate are added to the container. After 1 pass of the bead mill under the condition specified above, [Pigment wax liquid dispersion 3] is obtained. Ethyl acetate is added to adjust the density of the solid portion (at 130° C. for 30 minutes) of [Pigment wax liquid dispersion 3] to be 50%.

### Preparation of Aqueous Phase

995 parts of deionized water, 35 parts of a 25% aqueous solution of organic resin particulates (Copolymer of sodium salt of an adduct of sulfate with styrene-methacrylic acid-acrylic butylate-ethylene oxide methacrylate) for dispersion stability, 120 parts of a 48.5% aqueous solution of dodecyldiphenylether sodium disulfonate, and 90 parts of ethyl acetate are mixed and stirred to obtain [Aqueous phase 5].

### Emulsification Process

975 parts of [Pigment wax liquid dispersion 5] and 7.1 parts of isophorone diamine are mixed by a TK HOMOMIXER (manufactured by Tokushu Kika Kogyo Co., Ltd.) for one minute at a rotation of 5,000 rpm. 274 parts of [Prepolymer 1] are added followed by mixing by the TK HOMOMIXER for one minute at a rotation of 7,000 rpm. Then, 1,200 parts of [Aqueous phase 5] are added thereto followed by mixing by the TK HOMOMIXER for 20 minutes while controlling the rotation range thereof from 8,000 to 13,000 rpm. Thus, [Emulsion slurry 5] is prepared.

Thereafter, [Color toner 5] is obtained in the same manner as in the case of [Color toner 1] and has a volume average particle diameter (Dv) of 5.7 μm, an average circularity of 0.962 and a half effusion temperature of 163° C.

### Method of Manufacturing Color Toner 6

### Manufacturing of Liquid Dispersion (Oil Phase) of Pigment and Wax

The following is placed and mixed in a reaction container equipped with a stirrer and a thermometer:

| | |
|---|---|
| Polyester 1 | 545 parts |
| Paraffin wax (HNP-9, manufactured by | 55 parts |
| Nippon Seiro Co., Ltd.) | |
| Ethyl acetate | 1,450 parts |

The mixture is agitated, heated to 80° C., and kept at 80° C. for 5 hours and then cooled down to 30° C. in 1 hour. Then, 390 parts of [Master batch 1] and 100 parts of ethyl acetate are added to the reaction container and mixed for 1 hour to obtain [Liquid material 6].

Then, 1,500 parts of [Liquid material 6] is transferred to a reaction container and dispersed using a bead mill (ULTRAVISCOMILL from AIMEX) under the following conditions to disperse the pigment and the wax:

Liquid feeding speed: 1 kg/hr,

Disc rotation speed: 6 m/sec,

Diameter of zirconia beads: 0.5 mm,

Filling factor: 80% by volume, and

Repeat number of dispersion treatment: 3 times.

Next, 1,200 parts of 70% by weight of ethyl acetic acid solution of [Polyester 1] and 100 parts of ethyl acetate are added to the container. After 1 pass of the bead mill under the condition specified above, [Pigment wax liquid dispersion 6] is obtained. Ethyl acetate is added to adjust the density of the solid portion (at 130° C. for 30 minutes) of [Pigment wax liquid dispersion 3] to be 50%.

### Preparation of Aqueous Phase

970 parts of deionized water, 40 parts of a 25% aqueous solution of organic resin particulates (Copolymer of sodium salt of an adduct of sulfate with styrene-methacrylic acid-acrylic butylate-ethylene oxide methacrylate) for dispersion stability, 140 parts of a 48.5% aqueous solution of dodecyldiphenylether sodium disulfonate, and 90 parts of ethyl acetate are mixed and stirred to obtain [Aqueous phase 6].

### Emulsification Process

1,090 parts of [Pigment wax liquid dispersion 6] and 2.9 parts of isophorone diamine are mixed by a TK HOMOMIXER (manufactured by Tokushu Kika Kogyo Co., Ltd.) for one minute at a rotation of 5,000 rpm. 110 parts of [Prepolymer 1] are added followed by mixing by the TK HOMOMIXER for one minute at a rotation of 5,000 rpm. Then, 1,200 parts of [Aqueous phase 6] are added thereto followed by mixing by the TK HOMOMIXER for 20 minutes while controlling the rotation range thereof from 8,000 to 13,000 rpm. Thus, [Emulsion slurry 6] is prepared.

Thereafter, [Color toner 6] is obtained in the same manner as in the case of [Color toner 1] and has a volume average particle diameter (Dv) of 5.7 μm, an average circularity of 0.968 and a half effusion temperature of 139° C.

### Method of Manufacturing Color Toner 7

### Master Batch 2

The following is mixed by a HENSCHEL MIXER to obtain a mixture in which water is soaked in a pigment agglomeration body.

| | |
|---|---|
| Carbon black | 40 parts |
| Polyester 1 | 60 parts |
| Water | 30 parts |

The mixture is mixed and kneaded for 45 minutes by a two-roll with a surface temperature of the rolls of 130° C. The resultant is pulverized by a pulverizer to a size of 1 mm to obtain [Master batch 2].

### Manufacturing of Liquid Dispersion (Oil Phase) of Pigment and Wax

The following is placed and mixed in a reaction container equipped with a stirrer and a thermometer:

| | |
|---|---|
| Polyester 1 | 545 parts |
| Paraffin wax (HNP-9 manufactured by | 44 parts |
| Nippon Seiro Co., Ltd.) | |
| Ethyl acetate | 1,450 parts |

The mixture is agitated, heated to 80° C., and kept at 80° C. for 5 hours and then cooled down to 30° C. in 1 hour. Then, 350 parts of [Master batch 2] and 100 parts of ethyl acetate are added to the reaction container and mixed for 1 hour to obtain [Liquid material 7].

Then, 1,500 parts of [Liquid material 7] is transferred to a reaction container and dispersed using a bead mill (ULTRAVISCOMILL from AIMEX) under the following conditions to disperse the pigment and the wax:

Liquid feeding speed: 1 kg/hr,

Disc rotation speed: 6 m/sec,

Diameter of zirconia beads: 0.5 mm,

Filling factor: 80% by volume, and

Repeat number of dispersion treatment: 3 times.

Next, 600 parts of 70% by weight of ethyl acetic acid solution of [Polyester 1] and 100 parts of ethyl acetate are added to the container. After 1 pass of the bead mill under the condition specified above, [Pigment wax liquid dispersion 7] is obtained. Ethyl acetate is added to adjust the density of the solid portion (at 130° C. for 30 minutes) of [Pigment wax liquid dispersion 7] to be 50%.

### Preparation of Aqueous Phase

970 parts of deionized water, 40 parts of a 25% aqueous solution of organic resin particulates (Copolymer of sodium salt of an adduct of sulfate with styrene-methacrylic acid-acrylic butylate-ethylene oxide methacrylate) for dispersion stability, 140 parts of a 48.5% aqueous solution of dodecyldiphenylether sodium disulfonate, and 90 parts of ethyl acetate are mixed and stirred to obtain [Aqueous phase 7].

### Emulsification Process

975 parts of [Pigment wax liquid dispersion 7] and 7.5 parts of isophorone diamine are mixed by a TK HOMOMIXER (manufactured by Tokushu Kika Kogyo Co., Ltd.) for one minute at a rotation of 5,000 rpm. 289 parts of [Prepolymer 1] is added followed by mixing by the TK HOMOMIXER for one minute at a rotation of 7,000 rpm. Then, 1,200 parts of [Aqueous phase 7] are added thereto followed by mixing by the TK HOMOMIXER for 20 minutes while controlling the rotation range thereof from 8,000 to 13,000 rpm. Thus, [Emulsion slurry 7] is prepared.

Thereafter, [Color toner 7] is obtained in the same manner as in the case of [Color toner 1] and has a volume average particle diameter (Dv) of 5.6 μm, an average circularity of 0.968 and a half effusion temperature of 162° C.

### Method of Manufacturing Color Toner 8

### Manufacturing of Liquid Dispersion (Oil Phase) of Pigment and Wax

The following is placed and mixed in a reaction container equipped with a stirrer and a thermometer:

| | |
|---|---|
| Polyester 1 | 545 parts |
| Paraffin wax (HNP-9, manufactured by | 57 parts |
| Nippon Seiro Co., Ltd.) | |
| Ethyl acetate | 1,450 parts |

The mixture is agitated, heated to 80° C., and kept at 80° C. for 5 hours and then cooled down to 30° C. in 1 hour. Then, 415 parts of [Master batch 1] and 100 parts of ethyl acetate are added to the reaction container and mixed for 1 hour to obtain [Liquid material 8].

Then, 1,500 parts of [Liquid material 8] are transferred to a reaction container and dispersed using a bead mill (ULTRAVISCOMILL from AIMEX) under the following conditions to disperse the pigment and the wax:

Liquid feeding speed: 1 kg/hr,

Disc rotation speed: 6 m/sec,

Diameter of zirconia beads: 0.5 mm,

Filling factor: 80% by volume, and

Repeat number of dispersion treatment: 3 times.

Next, 600 parts of 70% by weight of ethyl acetic acid solution of [Polyester 1] and 100 parts of ethyl acetate are added to the container. After 1 pass of the bead mill under the condition specified above, [Pigment wax liquid dispersion 8] is obtained. Ethyl acetate is added to adjust the density of the solid portion (at 130° C. for 30 minutes) of [Pigment wax liquid dispersion 8] to be 50%.

### Preparation of Aqueous Phase

970 parts of deionized water, 40 parts of a 25% aqueous solution of organic resin particulates (Copolymer of sodium salt of an adduct of sulfate with styrene-methacrylic acid-acrylic butylate-ethylene oxide methacrylate) for dispersion stability, 140 parts of a 48.5% aqueous solution of dodecyldiphenylether sodium disulfonate, and 90 parts of ethyl acetate are mixed and stirred to obtain [Aqueous phase 8].

### Emulsification Process

1,090 parts of [Pigment wax liquid dispersion 8] and 1.9 parts of isophorone diamine are mixed by a TK HOMOMIXER (manufactured by Tokushu Kika Kogyo Co., Ltd.) for one minute at a rotation of 5,000 rpm. 74 parts of [Prepolymer 1] is added followed by mixing by the TK HOMOMIXER for one minute at a rotation of 5,000 rpm. Then, 1,200 parts of [Aqueous phase 8] are added thereto followed by mixing by the TK HOMOMIXER for 20 minutes while controlling the rotation range thereof from 8,000 to 13,000 rpm. Thus, [Emulsion slurry 8] is prepared.

Thereafter, [Color toner 8] is obtained in the same manner as in the case of [Color toner 1] and has a volume average particle diameter (Dv) of 5.7 μm, an average circularity of 0.968 and a half effusion temperature of 134° C.

### Method of Manufacturing Color Toner 9

360 parts of deionized water and 430 parts of 0.1 mole/litter of Na₃PO₄ are placed in a container and the temperature of the system is maintained at 60° C. while stirring by a high speed stirring HOMOMIXER at a rotation speed of 15,000 rpm. 34 parts of 1.0 mole/litter of CaCl₂ solution is slowly added to the container to obtain an aqueous medium dispersion body containing a fine dispersion stabilizer Ca₃ (PO₄)₂ hardly soluble in water.

The mixture formed of the following recipe as a dispersoid is dispersed by an attritor (manufactured by Mitsui Mining and Smelting Co., Ltd.) for 3 hours:

| | |
|---|---|
| Styrene monomer | 83 parts |
| n-butylacrylate | 17 parts |
| Copper phthalocyanine pigment | 6.5 parts |
| 3,5-di-tert-butyl aluminum salicylate pigment | 0.8 parts |
| Divinylbenzene | 2 parts |
| Paraffin Wax (HNP-9, manufactured by | 2 parts |
| Nippon Seiro Co., Ltd.) | |
| Polyester resin (Mw = 25,000, Acid value: | 5 parts |
| 15 mgKOH/g) | |

Then, 3 parts of 2,2′-azobis(2,4-dimethyl valeronitrile) are added to the mixture to prepare a polymerizable monomer composition.

Next, the polymerizable monomer composition is placed in the aqueous medium dispersion body and dispersed in N₂ atmosphere having an inner temperature of 60° C. for 4 minutes to granulate the polymerizable monomer composition while maintaining the rotation number of the high speed stirring HOMOMIXER at 15,000 rpm. Thereafter, the stirring device is replaced with a stirring device having a paddle stirring wing to conduct polymerization for 5 hours while maintaining the same temperature and stirring at 200 rpm.

After the polymerization, the inner temperature is elevated to 80° C. to conduct polymerization reaction more. Then, subsequent to cooling down, dilute hydrochloric acid is added to cause the aqueous medium dispersion body to have a pH of 1.2 to dissolve the fine dispersion stabilizer Ca₃ (PO₄)₂ hardly soluble in water. Furthermore, after isolating liquid from solid by pressure filtration, the solid is washed by 18,000 parts of water. Thereafter, the resultant is sufficiently dried by a vacuum drier to obtain a mother toner having a cyan color.

The physical properties of the color toners 1 to 9 are shown in Tables 1-1 and 1-2.

### Method of Manufacturing Transparent and Colorless Resin Particulate

### Manufacturing of Liquid Dispersion (Oil Phase) of Wax

The following is placed and mixed in a reaction container equipped with a stirrer and a thermometer:

| | |
|---|---|
| Polyester 1 | 545 parts |
| Paraffin wax (HNP-9, manufactured by | 138 parts |
| Nippon Seiro Co., Ltd.) | |
| Ethyl acetate | 1,450 parts |

The mixture is agitated, heated to 80° C., and kept at 80° C. for 5 hours and then cooled down to 30° C. in 1 hour. Then, 100 parts of ethyl acetate are added to the reaction container and mixed for 1 hour to obtain [Liquid material 101].

Then, 1,300 parts of [Liquid material 101] is transferred to a reaction container and dispersed using a bead mill (ULTRAVISCOMILL from AIMEX) under the following conditions to disperse the wax:

Liquid feeding speed: 1 kg/hr,

Disc rotation speed: 6 m/sec,

Diameter of zirconia beads: 0.5 mm,

Filling factor: 80% by volume, and

Repeat number of dispersion treatment: 3 times.

Next, 600 parts of 70% by weight of ethyl acetic acid solution of [Polyester 1] and 820 parts of 60% by weight of ethyl acetic acid solution of [Polyester 2], and 100 parts of ethyl acetate are added to the container. After 1 pass of the bead mill under the condition specified above, [Wax liquid dispersion 101] is obtained. Ethyl acetate is added to adjust the density of the solid portion (at 130° C. for 30 minutes) of [Wax liquid dispersion 101] to be 50%.

### Preparation of Aqueous Phase

970 parts of deionized water, 35 parts of a 25% aqueous solution of organic resin particulates (Copolymer of sodium salt of an adduct of sulfate with styrene-methacrylic acid-acrylic butylate-ethylene oxide methacrylate) for dispersion stability, 120 parts of a 48.5% aqueous solution of dodecyldiphenylether sodium disulfonate, and 90 parts of ethyl acetate are mixed and stirred to obtain [Aqueous phase 101].

### Emulsification Process

975 parts of [Wax liquid dispersion 101 are mixed by a TK HOMOMIXER (manufactured by Tokushu Kika Kogyo Co., Ltd.) for one minute at a rotation of 5,000 rpm. Thereafter, 1,200 parts of [Aqueous phase 101] are added thereto followed by mixing by the TK HOMOMIXER for 20 minutes while controlling the rotation range thereof from 8,000 to 13,000 rpm. Thus, [Emulsion slurry 101] is prepared.

Thereafter, [Transparent and colorless resin particulate 1] is obtained in the same manner as in the case of [Color toner 1] and has a volume average particle diameter (Dv) of 6.6 am, an average circularity of 0.964 and a half effusion temperature of 122° C.

### Method of Manufacturing Transparent and Colorless Resin Particulate 2

### Manufacturing of Liquid Dispersion (Oil Phase) of Wax

The following is placed and mixed in a reaction container equipped with a stirrer and a thermometer:

| | |
|---|---|
| Polyester 1 | 545 parts |
| Paraffin wax (HNP-9, manufactured by | 10 parts |
| Nippon Seiro Co., Ltd.) | |
| Ethyl acetate | 1,450 parts |

The mixture is agitated, heated to 80° C., and kept at 80° C. for hours and then cooled down to 30° C. in 1 hour. Then, 100 parts of ethyl acetate are added to the reaction container and mixed for 1 hour to obtain [Liquid material 102].

Then, 1,300 parts of [Liquid material 102] is transferred to a reaction container and dispersed using a bead mill (ULTRAVISCOMILL from AIMEX) under the following conditions to disperse the wax:

Liquid feeding speed: 1 kg/hr,

Disc rotation speed: 6 m/sec,

Diameter of zirconia beads: 0.5 mm,

Filling factor: 80% by volume, and

Repeat number of dispersion treatment: 3 times.

Next, 580 parts of 70% by weight of ethyl acetic acid solution of [Polyester 1] and 825 parts of 60% by weight of ethyl acetic acid solution of [Polyester 2], and 100 parts of ethyl acetate are added to the container. After 1 pass of the bead mill under the condition specified above, [Wax liquid dispersion 102] is obtained. Ethyl acetate is added to adjust the density of the solid portion (at 130° C. for 30 minutes) of [Wax liquid dispersion 102] to be 50%.

Thereafter, [Transparent and colorless resin particulate 2] is obtained in the same manner as in the case of [Color toner 1] and has a volume average particle diameter (Dv) of 6.8 μm, an average circularity of 0.964 and a half effusion temperature of 121° C.

### Method of Manufacturing Transparent and Colorless Resin Particulate 3

Manufacturing of Liquid Dispersion (Oil Phase) of Wax

The following is placed and mixed in a reaction container equipped with a stirrer and a thermometer:

| | |
|---|---|
| Polyester 1 | 545 parts |
| Paraffin wax (HNP-9, manufactured by | 138 parts |
| Nippon Seiro Co., Ltd.) | |
| Ethyl acetate | 1,450 parts |

The mixture is agitated, heated to 80° C., and kept at 80° C. for 5 hours and then cooled down to 30° C. in 1 hour. Then, 100 parts of ethyl acetate are added to the reaction container and mixed for 1 hour to obtain [Liquid material 103].

Then, 1,400 parts of [Liquid material 103] is transferred to a reaction container and dispersed using a bead mill (ULTRAVISCOMILL from AIMEX) under the following conditions to disperse the wax:

Liquid feeding speed: 1 kg/hr,

Disc rotation speed: 6 m/sec,

Diameter of zirconia beads: 0.5 mm,

Filling factor: 80% by volume, and

Repeat number of dispersion treatment: 3 times.

Next, 180 parts of 70% by weight of ethyl acetic acid solution of [Polyester 1] and 1,450 parts of 60% by weight of ethyl acetic acid solution of [Polyester 2], and 50 parts of ethyl acetate are added to the container. After 1 pass of the bead mill under the condition specified above, [Wax liquid dispersion 103] is obtained. Ethyl acetate is added to adjust the density of the solid portion (at 130° C. for 30 minutes) of [Wax liquid dispersion 103] to be 50%.

Thereafter, [Transparent and colorless resin particulate 3] is obtained in the same manner as in the case of [Color toner 1] and has a volume average particle diameter (Dv) of 6.6 μm, an average circularity of 0.966 and a half effusion temperature of 138° C.

### Method of Manufacturing Transparent and Colorless Resin Particulate 4

Transparent and colorless [Transparent and Colorless Resin Particulate 4] is manufactured in the same manner as in [Transparent and Colorless Resin Particulate 3] except that [Polyester 2] is changed to [Styrene-acryl resin 1] (referred to as StAc in Table 1) and [Transparent and Colorless Resin Particulate 4] has a volume average particle diameter (Dv) of 6.3 μm, an average circularity of 0.962 and a half effusion temperature of 129° C.

### Method of Manufacturing Transparent and Colorless Resin Particulate 5

Transparent and colorless [Transparent and Colorless Resin Particulate 5] is manufactured in the same manner as in [Transparent and Colorless Resin Particulate 3] except that [Polyester 1] and [Polyester 2] are changed to [Styrene-acryl resin 1] (referred to as StAc in Table 1) and [Transparent and Colorless Resin Particulate 5] has a volume average particle diameter (Dv) of 6.3 μm, an average circularity of 0.962 and a half effusion temperature of 126° C.

The transparent and colorless resin particulates 1 to 5 are shown in Tables 2-1 and 2-2.

Next, manufacturing examples of the pressure roller in the fixing device are described.

### Manufacturing Example 1 of Pressure Roller

Silicone rubber foam having a hardness of 57° according to ASKER C is compress-molded to cover a core metal steel tube for mechanical structure having an outer diameter of 30 mm at the center portion thereof and the surface of the silicone rubber foam is thereafter ground. The surface is covered by a PFA releasing layer having a sheet form having a surface roughness Rz of 2.7 μm to obtain a pressure roller 1 having an outer diameter of 35 mm at the center portion thereof. The pressure roller 1 has a hardness of 58° according to ASKER C.

### Manufacturing Example 2 of Pressure Roller

Silicone rubber foam having a hardness of 45° according to ASKER C is compress-molded to cover a core metal steel tube for mechanical structure having an outer diameter of 30 mm at the center portion thereof and the surface of the silicone rubber foam is thereafter ground. The surface is covered by a PFA releasing layer having a sheet form having a surface roughness Rz of 2.7 μm to obtain a pressure roller 2 having an outer diameter of 35 mm at the center portion thereof. The pressure roller 2 has a hardness of 47 according to ASKER C.

### Manufacturing Example 3 of Pressure Roller

Silicone rubber foam having a hardness of 75° according to ASKER C is compress-molded to cover a core metal steel tube for mechanical structure having an outer diameter of 30 mm at the center portion thereof and the surface of the silicone rubber foam is thereafter ground. The surface is covered by a PFA releasing layer having a sheet form having a surface roughness Rz of 2.7 μm to obtain a pressure roller 3 having an outer diameter of 35 mm at the center portion thereof. The pressure roller 3 has a hardness of 77 according to ASKER C.

### Manufacturing Example 4 of Pressure Roller

Silicone rubber foam having a hardness of 57° according to ASKER C is compress-molded to cover a core metal steel tube for mechanical structure having an outer diameter of 30 mm at the center portion thereof and the surface of the silicone rubber foam is thereafter ground. The surface is covered by a PFA releasing layer having a sheet form having a surface roughness Rz of 2.7 μm to obtain a pressure roller 4 having an outer diameter of 35 mm at the center portion thereof. The pressure roller 4 has a hardness of 38 according to ASKER C.

### Manufacturing Example 5 of Pressure Roller

Silicone rubber foam having a hardness of 84° according to ASKER C is compress-molded to cover a core metal steel tube for mechanical structure having an outer diameter of 30 mm at the center portion thereof and the surface of the silicone rubber foam is thereafter ground. The surface is covered by a PFA releasing layer having a sheet form having a surface roughness Rz of 2.7 μm to obtain a pressure roller 5 having an outer diameter of 35 mm at the center portion thereof. The pressure roller 5 has a hardness of 84 according to ASKER C.

The fixing unit is removed from a color printer (IPSiO SP C220, manufactured by Ricoh Co., Ltd.) and remodeled such that the process speed can be arbitrarily changed by a driving force provided outside to obtain a fixing unit 1 for test.

### Example 1

A remodeled machine based on a color printer (IPSiO SP C220, manufactured by Ricoh Co., Ltd.) is prepared by removing the fixing device therefrom. After removing development agents accommodated in the development units of black toner and cyan toner in this remodeled machine followed by decomposition, cleaning and reassembly of the development units, a two component development agent formed by mixing and stirring 5 parts of [Color toner 1] and 95 parts of a silicone resin coated carrier is placed in the emptied out development unit for black toner and a two component development agent formed by mixing and stirring 5 parts of [Transparent and colorless resin particulate 1] and 95 parts of a silicone resin coated carrier is placed in the emptied out development unit for cyan toner.

The machine is adjusted such that the color toner is developed in an amount of from 0.4 to 0.6 mg/cm² and the transparent and colorless resin particulates is developed in an amount of from 0.6 to 0.8 mg/cm² when a solid image is printed on transfer paper (Type 6200, paper passing direction perpendicular to machine direction) and transfer paper on which an image is not fixed yet can be output.

An unfixed image (A) which is “ABCDEF” with a font of “Times New Roman” having a size of 3 point is output with the color toner on transfer paper while a solid image of the colorless resin particulates is overlapped with the color image.

Next, an unfixed image (B) of a square of 40 mm² is output with the color toner on transfer paper while a square of 60 mm² of the transparent and colorless resin particulates is overlapped with the square of the color toner.

In addition, an unfixed image (C) of a gray scale (half tone) formed by dots having a size of 150 mm² is output with the color toner on transfer paper while a square of 200 mm² of the transparent and colorless resin particulates is overlapped with the image of the color toner.

An unfixed image (D) of a square of 20 mm² is output with the color toner on a transparent sheet while a square of 30 mm² of the transparent and colorless resin particulates is overlapped with the square of the color toner.

The pressure roller of the fixing unit 1 for test is replaced with the pressure roller 1 and thereafter, the unfixed image (A), the unfixed image (B) and the unfixed image (C) are sequentially fixed when passing through the fixing unit 1 set to have a process speed of 160 mm/sec and a temperature of the fixing roller in the range of from 166 to 174° C. to obtain a fixed image (A), a fixed image (B) and a fixed image (C).

Next, the obtained toner kits are evaluated according to the following evaluation method. The evaluation results are shown in Table 3.

### Gloss

The degree of the gloss of the colored portion of the fixed image (B) is measured by a gloss meter (manufactured by Nippon Denshoku Industries Co., Ltd.) with an incident angle of light of 60°. An image having a gloss degree scaled 3 or higher has no practical problem.

E (Excellent): the degree of gloss is from 14 to less than 30
G (good): the degree of gloss is from 6 to less than 14
F (Fair): the degree of gloss is from 3 to less than 6
B (Bad): the degree of gloss is less than 3

### Transparency of Transparent Sheet

The optical light transmission factor of the colored portion with regard to the fixed image (D) is measured by a 330 type magnetic spectrophotometer (manufactured by Hitachi limited) with reference to an unused transparent sheet on which no toner is borne to obtain the difference of the optical light transmission factor between 500 nm and 600 nm. A color image has no practical problem when this value is 70% or higher and has good transparency when this value is 80% or higher, meaning that the color representability is good.

E (Excellent): the difference between optical light transmission factors is 90% or higher
G (Good): the difference between optical light transmission factors is from 80% to less than 90%
F (Fair): the difference between optical light transmission factors is from 70% to less than 80%
B (Bad): the difference between optical light transmission factors is less than 70%.

### Fixing Strength

An automatic drawing machine (AD-401, manufactured by Ueshima Seisakusho Co., Ltd.) is used to travel a sapphire needle of 125 μR on the colored portion of the fixed image (B) under the conditions of a needle rotation diameter of 8 mm and a load of 1 g and the traveling surface of the point of the sapphire needle is observed to find out the occurrence status of scratch (traveling trace) and evaluated according to the following. An image having a scratch recognized as a white spot has no practical problem.

E (Excellent): no trace (line) is observed
G (Good): scratches are slightly observed as white spots
F (Fair): scratches are observed as white spots
B (Bad): scratches are observed as white lines.

### Edge Rerproducibility

The fixed image (A) is observed by a magnifying glass and the image status is observed by naked eyes. Images scaled from excellent to fair are preferable.

E (Excellent): the ends of “C” and the fine lines of “A” are clearly printed
G (Good): the ends of “C” is slightly crushed but the fine lines of “A” are clearly printed
F (Fair): the ends of “C” is crushed but the fine lines of “A” are rough
B (Bad): the ends of “C” and the fine lines of “A” are crushed.

### Granularity

An image data are obtained by scanning an original by a scanner (GenaScan 5000, manufactured by Dainippon screen MFG Co., Ltd.) with 1,000 dpi. The image data are converted into the density distribution and the granularity is evaluated according to the following relationships (1) to (3).

Granularity (GS)=exp(−1.8<D>)∫WS(u)1/2VTF(u)du Relationship (1)

In the relationship (1), exp(−1.8<D>) is a coefficient to correct the density and the luminosity recognized by a man and <D> represents the density average.

In addition, WS can be obtained by the following relationships (2) and (3) when the density variance component with the average being equal to 0 is fx(dx):

F(u)=f(x)exp(−2∫iux)dx Relationship (2)

Ws(u)=F(u)2 Relationship (3)

In the relationships (2) and (3), u represents space frequency.

The granularity has a high relation with the subjective evaluation for smoothness of an image. A quality image has a small granularity value and to the contrary, a rough image of poor quality has a large granularity value. An image having a granularity of 0.5 or higher has a practical problem with regard to print grade.

E (Excellent): to less than 0.1
G (Good): 0.1 to less than 0.3
F (Fair): 0.3 to less than 0.5
B (Bad): 0.5 or higher.

### Examples 2 to 8 and Example 10

Each machine of Examples 2 to 8 and Example 10 is manufactured and evaluated in the same manner as in Example 1 except that the pressure roller, the color toner and the transparent and colorless resin particulates are changed to those shown in Table 3.

### Example 9

### Example 9 which is prepared in the same manner as in Example 1 except that [Color toner 1] is replaced with [Color toner 7] is evaluated in the same manner as in Example 1. However, since the color toner 7 is black, Example 9 is not evaluated with regard to the transparency of transparent sheet.

### Examples 11, 12 and 13

Each machine of Examples 11, 12 and 13 is manufactured and evaluated in the same manner as in Example 1 except that the pressure roller, the color toner and the transparent and colorless resin particulates are changed to those shown in Table 3. The evaluation results are shown in Table 3.

### Comparative Examples 1, 2 and 6

Each machine of Comparative Examples 1, 2 and 6 is manufactured and evaluated in the same manner as in Example 1 except that the pressure roller, the color toner and the transparent and colorless resin particulates are changed to those shown in Table 3. The evaluation results are shown in Table 3.

### Comparative Example 3

Comparative Example 3 is evaluated in the same manner as in Example 1 except that no development is set in the development unit for cyan toner. The evaluation results are shown in table 3.

### Comparative Examples 4 and 5

Each machine of Comparative Examples 4 and 5 is evaluated in the same manner as in Comparative Example 1 except that the pressure roller and the color toner are changed to those shown in Table 3. The evaluation results are shown in Tables 3-1 and 3-2.

TABLE 1-1

| | |
|---|---|
| Resin | |
| composition | |
| ratio | Coloring agent |

| | Pes | StAc | | Quantity |
|---|---|---|---|---|
| | (%) | (%) | Kind | (% by weight) |
| Color | 100 | 0 | PB15:3 | 6.5 |
| toner 1 | | | | |
| Color | 100 | 0 | PB15:3 | 6.5 |
| toner 2 | | | | |
| Color | 100 | 0 | PB15:3 | 6.5 |
| toner 3 | | | | |
| Color | 100 | 0 | PB15:3 | 6.5 |
| toner 4 | | | | |
| Color | 100 | 0 | PB15:3 | 6.5 |
| toner 5 | | | | |
| Color | 100 | 0 | PB15:3 | 6.5 |
| toner 6 | | | | |
| Color | 100 | 0 | Carbon | 6.5 |
| toner 7 | | | black | |
| Color | 100 | 0 | PB15:3 | 6.5 |
| toner 8 | | | | |
| Color | 0 | 100 | PB15:3 | 6.5 |
| toner 9 | | | | |

TABLE 1-2

| | Wax | | Toner physical property | | |
|---|---|---|---|---|---|
| | | Quantity | Particle | | Half effusion |
| | Kind | (%) | diameter (μm) | Circularity | temp. (° C.) |
| Color | paraffin | 2 | 5.6 | 0.966 | 159 |
| toner 1 | | | | | |
| Color | paraffin | 2 | 8.8 | 0.958 | 160 |
| toner 2 | | | | | |
| Color | paraffin | 2 | 9.1 | 0.941 | 158 |
| toner 3 | | | | | |
| Color | — | — | 5.8 | 0.961 | 162 |
| toner 4 | | | | | |
| Color | paraffin | 6 | 5.7 | 0.962 | 163 |
| toner 5 | | | | | |
| Color | paraffin | 2 | 5.7 | 0.968 | 139 |
| toner 6 | | | | | |
| Color | paraffin | 2 | 5.6 | 0.968 | 162 |
| toner 7 | | | | | |
| Color | paraffin | 2 | 5.7 | 0.968 | 134 |
| toner 8 | | | | | |
| Color | paraffin | 2 | 6.9 | 0.979 | 159 |
| toner 9 | | | | | |

Pes: polyester unit
StAc: Vinyl polymer unit

TABLE 2-1

| | |
|---|---|
| Resin | |
| composition | |
| ratio | Wax |

| | Pes | | | Quantity |
|---|---|---|---|---|
| | (%) | StAc | Kind | (%) |
| Transparent | 100 | 0 | paraffin | 6 |
| and colorless | | | | |
| resin | | | | |
| particulate 1 | | | | |
| Transparent | 100 | 0 | paraffin | 0.5 |
| and colorless | | | | |
| resin | | | | |
| particulate 2 | | | | |
| Transparent | 100 | 0 | paraffin | 6 |
| and colorless | | | | |
| resin | | | | |
| particulate 3 | | | | |
| Transparent | 60 | 40 | paraffin | 6 |
| and colorless | | | | |
| resin | | | | |
| particulate 4 | | | | |
| Transparent | 0 | 100 | paraffin | 6 |
| and colorless | | | | |
| resin | | | | |
| particulate 5 | | | | |

TABLE 2-2

| | Toner physical property | | |
|---|---|---|---|
| | | | Half |
| | Particle | | effusion |
| | diameter | | temp. |
| | (μm) | Circularity | (° C.) |
| Transparent and | 6.6 | 0.964 | 122 |
| colorless resin | | | |
| particulate 1 | | | |
| Transparent and | 6.8 | 0.964 | 121 |
| colorless resin | | | |
| particulate 2 | | | |
| Transparent and | 6.6 | 0.966 | 138 |
| colorless resin | | | |
| particulate 3 | | | |
| Transparent and | 6.3 | 0.962 | 129 |
| colorless resin | | | |
| particulate 4 | | | |
| Transparent and | 6.3 | 0.962 | 126 |
| colorless resin | | | |
| particulate 5 | | | |

Pes: polyester unit
StAc: Vinyl polymer unit

TABLE 3-1

| | |
|---|---|
| Fixing condition | Transparent |

| | | Hardness | | and |
|---|---|---|---|---|
| | | of | | colorless |
| | Pressure | Pressure | Color | resin |
| | roller | roller | toner | particulate |
| Example 1 | Pressure | 58 | Color | Transparent |
| | roller 1 | | toner 1 | and |
| | | | | colorless |
| | | | | resin |
| | | | | particulate 1 |
| Example 2 | Pressure | 58 | Color | Transparent |
| | roller 1 | | toner 2 | and |
| | | | | colorless |
| | | | | resin |
| | | | | particulate 1 |
| Example 3 | Pressure | 58 | Color | Transparent |
| | roller 1 | | toner 3 | and |
| | | | | colorless |
| | | | | resin |
| | | | | particulate 1 |
| Example 4 | Pressure | 58 | Color | Transparent |
| | roller 1 | | toner 1 | and |
| | | | | colorless |
| | | | | resin |
| | | | | particulate 4 |
| Example 5 | Pressure | 58 | Color | Transparent |
| | roller 1 | | toner 5 | and |
| | | | | colorless |
| | | | | resin |
| | | | | particulate 1 |
| Example 6 | Pressure | 58 | Color | Transparent |
| | roller 1 | | toner 4 | and |
| | | | | colorless |
| | | | | resin |
| | | | | particulate 1 |
| Example 7 | Pressure | 47 | Color | Transparent |
| | roller 2 | | toner 1 | and |
| | | | | colorless |
| | | | | resin |
| | | | | particulate 1 |
| Example 8 | Pressure | 77 | Color | Transparent |
| | roller 3 | | toner 1 | and |
| | | | | colorless |
| | | | | resin |
| | | | | particulate 1 |
| Example 9 | Pressure | 58 | Color | Transparent |
| | roller 1 | | toner 7 | and |
| | | | | colorless |
| | | | | resin |
| | | | | particulate 1 |
| Example 10 | Pressure | 58 | Color | Transparent |
| | roller 1 | | toner 1 | and |
| | | | | colorless |
| | | | | resin |
| | | | | particulate 2 |
| Example 11 | Pressure | 38 | Color | Transparent |
| | roller 4 | | toner 1 | and |
| | | | | colorless |
| | | | | resin |
| | | | | particulate 1 |
| Example 12 | Pressure | 84 | Color | Transparent |
| | roller 5 | | toner 1 | and |
| | | | | colorless |
| | | | | resin |
| | | | | particulate 1 |
| Example 13 | Pressure | 58 | Color | Transparent |
| | roller 1 | | toner 9 | and |
| | | | | colorless |
| | | | | resin |
| | | | | particulate 5 |
| Comparative | Pressure | 58 | Color | Transparent |
| Example 1 | roller 1 | | toner 6 | and |
| | | | | colorless |
| | | | | resin |
| | | | | particulate 1 |
| Comparative | Pressure | 58 | Color | Transparent |
| Example 2 | roller 1 | | toner 1 | and |
| | | | | colorless |
| | | | | resin |
| | | | | particulate 3 |
| Comparative | Pressure | 58 | Color | — |
| Example 3 | roller 1 | | toner 1 | |
| Comparative | Pressure | 84 | Color | — |
| Example 4 | roller 5 | | toner 1 | |
| Comparative | Pressure | 58 | Color | — |
| Example 5 | roller 1 | | toner 6 | |
| Comparative | Pressure | 58 | Color | Transparent |
| Example 6 | roller 1 | | toner 8 | and |
| | | | | colorless |
| | | | | resin |
| | | | | particulate 3 |

TABLE 3-2

| | | Evaluation results | | | | |
|---|---|---|---|---|---|---|
| | Half | | Transparency | | | |
| | effusion | | of | | | |
| | temp. | | transparent | Fixing | Edge | |
| | (° C.) | Gloss | sheet | strength | Rerproducibility | Granularity |
| Example 1 | 37 | E | G | E | E | E |
| Example 2 | 38 | E | G | E | F | G |
| Example 3 | 36 | E | G | E | F | F |
| Example 4 | 35 | E | F | F | E | E |
| Example 5 | 41 | E | F | E | E | E |
| Example 6 | 40 | E | E | E | E | E |
| Example 7 | 37 | G | G | E | E | E |
| Example 8 | 37 | G | G | E | E | E |
| Example 9 | 40 | E | —* | E | E | E |
| Example 10 | 38 | E | G | E | E | E |
| Example 11 | 37 | F | F | F | E | E |
| Example 12 | 37 | F | F | E | E | E |
| Example 13 | 33 | E | G | E | E | E |
| Comparative | 17 | E | G | E | F | B |
| Example 1 | | | | | | |
| Comparative | 21 | F | B | F | E | E |
| Example 2 | | | | | | |
| Comparative | — | B | B | B | E | E |
| Example 3 | | | | | | |
| Comparative | — | G | F | F | B | F |
| Example 4 | | | | | | |
| Comparative | — | G | G | G | B | B |
| Example 5 | | | | | | |
| Comparative | −4 | G | F | G | B | B |
| Example 6 | | | | | | |

—*: Since black toner is used, Example 9 is not evaluated with regard to transparency of transparent sheet.

This document claims priority and contains subject matter related to Japanese Patent Application No. 2008-145987, filed on Jun. 3, 2008, the entire contents of which are incorporated herein by reference.

Having now fully described the invention, it will be apparent to one of ordinary skill in the art that many changes and modifications can be made thereto without departing from the spirit and scope of the invention as set forth therein.

What is claimed as new and desired to be secured by Letters Patent of the United States is:

1. A toner kit comprising:
a color toner comprising a first binder resin and a coloring agent; and
transparent and colorless resin particulates comprising a second binder resin,
wherein a half effusion temperature of the color toner and a half effusion temperature of the transparent and colorless resin particulates measured by a flow tester satisfy the following relationship:
(the half effusion temperature of the color toner measured by the flow tester)−(the half effusion temperature of the transparent and colorless particulates measured by the flow tester)>30° C.

2. The toner kit according to claim 1, wherein the half effusion temperature of the color toner measured by the flow tester is 150° C. or higher, and the half effusion temperature of the transparent and colorless resin particulates measured by the flow tester is 120° C. or lower.

3. The toner kit according to claim 1, wherein the color toner has a volume average particle diameter of from 2 to 8 μm.

4. The toner kit according to claim 1, wherein the color toner has an average circularity of 0.950 or higher.

5. The toner kit according to claim 1, wherein the transparent and colorless resin particulates further comprises a releasing agent in an amount of from 2 to 40% by weight.

6. The toner kit according to claim 5, wherein the color toner further comprises a releasing agent in an amount of 4% or lower by weight.

7. The toner kit according to claim 1, wherein 70% by weight of the first binder of the color toner and 70% by weight of the second binder of the transparent and colorless resin particulates comprise polyester units.

8. The toner kit according to claim 1, wherein 70% by weight of the first binder resin of the color toner and 70% by weight of the second binder resin of the transparent and colorless resin particulates comprise vinyl polymer units.

9. An image forming apparatus comprising:
at least one first image bearing member, each configured to bear a first latent electrostatic image thereon;
a second image bearing member configured to bear a second latent electrostatic image thereon;
at least one first charging device, each configured to uniformly and correspondingly charge a surface of one of the at least one first image bearing member;
a second charging device configured to uniformly and correspondingly charge a surface of the second image bearing member;
an irradiation device configured to irradiate each surface of the at least one first image bearing member and the second image bearing member according to image data to respectively write the first latent electrostatic image on each of the surface of each of the at least one first image bearing member and the second latent electrostatic image on the second image bearing member;
at least one first development device, each comprising a first development agent bearing member configured to bear a first development agent comprising a color toner comprising a first binder resin and a coloring agent on a surface of the first development agent bearing member, a first development agent container configured to accommodate the first development agent, and a first development agent supplying member configured to supply the first development agent to the surface of the first development agent bearing member, the at least one first development device being configured to develop the first latent electrostatic image on each surface of the at least one first image bearing member with the color toner to obtain at least one visualized image;
a second development device comprising a second development agent bearing member configured to bear a second development agent comprising a transparent and colorless resin particulates comprising a second binder resin on a surface of the second development agent bearing member, a second development agent container configured to accommodate the second development agent, and a second development agent supplying member configured to supply the second development agent to the surface of the second development agent bearing member, the second development device being configured to form a transparent and colorless image on the surface of the second image bearing member with the transparent and colorless resin particulates;
a transfer device configured to transfer the at least one visualized image and the transparent and colorless image to a recording medium; and
a fixing device configured to fix the at least one visualized image and the transparent and colorless image on the recording medium,
wherein a half effusion temperature of the color toner and a half effusion temperature of the transparent and colorless resin particulates measured by a flow tester satisfy the following relationship:
(the half effusion temperature of the color toner measured by the flow tester)−(the half effusion temperature of the transparent and colorless particulates measured by the flow tester)>30° C.

10. The image forming apparatus according to claim 9, wherein the fixing device comprises a heating device comprising an elastic layer and a heat source, and a pressure device which forms a nip portion with the heating device where the recording medium is nipped by the heating device and the pressure device and the pressure device has an ASKER C hardness of from 45 to 80°.

11. An image formation method comprising:
forming an image formed of color toner and a transparent and colorless image formed of transparent and colorless resin particulates to obtain a toner image; and
fixing the toner image on a recording medium,
wherein the color toner comprises a first binder resin and a coloring agent and the transparent and colorless resin particulates comprise a second binder resin and,
wherein a half effusion temperature of the color toner and a half effusion temperature of the transparent and colorless resin particulates measured by a flow tester satisfy the following relationship:
(the half effusion temperatures of the color toner measured by the flow tester)−(the half effusion temperatures of the transparent and colorless particulates measured by the flow tester)>30° C.

12. The image formation method according to claim 11, wherein the half effusion temperature of the color toner measured by the flow tester is 150° C. or higher, and the half effusion temperature of the transparent and colorless particulates measured by the flow tester is 120° C. or lower.

13. The image formation method according to claim 11, wherein the step of fixing is conducted when the recording medium bearing unfixed toner image formed of the color toner and the transparent and colorless resin particulates passes through a nip portion where a heating device comprising an elastic layer and a heat source nip the recording medium with and a pressure device.

14. The image formation method according to claim 11, wherein the pressure device has an ASKER C hardness of from 45 to 80°.

15. The image formation method according to claim 13, wherein the recording medium passes through the nip portion at from 150 to 500 mm/s.
